(19) United States
(12) Patent Application Publication
(10) Pub. No.: US 2026/0291963 A1
(43) Pub. Date: Sep. 24, 2026

(54) Anomaly Detection Using Hybrid Neural Network Framework

(71) Applicant: Bank of America Corporation, Charlotte, NC (US)

(72) Inventors: Mullaikani A., Tamil Nadu (IN); Manu Kurian, Dallas, TX (US)

(21) Appl. No.: 19/082,449

(22) Filed: Mar. 18, 2025

(51) Int. Cl. H04L 9/40; G06N 10/20; G06N 10/60; H04L 9/08; H04L 41/16

(52) U.S. Cl. CPC H04L 63/1425; G06N 10/20; G06N 10/60; H04L 9/0852; H04L 41/16

(57) ABSTRACT

A hybrid quantum-classical framework detects anomalies in network data by integrating quantum and classical neural networks. Data acquisition collects user inputs and network traffic, forming a raw dataset preprocessed with SHA3 hashing and SPHINCS+ quantum-safe signatures for integrity. Quantum encoding with BB84 QKD and CNOT gate entanglement secures quantum transfers, while a quantum neural network validates data, normalizes it, and applies amplitude encoding to extract features using variational quantum circuits with RY/RZ gates, optimized via gradient descent. A variational quantum recurrent network with quantum memory classifies anomalies, thresholding scores at 0.9 to generate severity-ranked alerts. A classical convolutional neural network analyzes spatial patterns, with a multi-translation layer fusing quantum and classical outputs. An integration module combines results, adjusts circuit depth, monitors latency, and logs anomalies to persistent storage, ensuring real-time, comprehensive anomaly detection across diverse network environments.

### TECHNICAL FIELD

The inventions disclosed herein pertain to multiple technical fields within the realm of advanced data processing and security technologies. They encompass the domain of artificial intelligence, where hybrid neural network frameworks integrate quantum and traditional neural networks to analyze complex, high-dimensional datasets for pattern recognition and anomaly detection using variational quantum circuits. Additionally, the inventions address security in digital systems by employing quantum-safe digital signatures, such as hash-based schemes, to ensure data authenticity and integrity during transmission, aligning with cryptographic and secure communication methodologies. The technology also involves real-time monitoring and validation of data through quantum-enhanced techniques, fitting into the field of error detection and system integrity management. Furthermore, the development and optimization of this sophisticated software-based detection system, leveraging quantum and classical processing layers, correspond to advancements in software simulation and testing. Lastly, the use of quantum encoding, entanglement, and quantum neural networks ties the invention to the application of quantum effects in computational technologies, reflecting cutting-edge nanotechnology applications. Together, these fields highlight a multidisciplinary approach to enhancing cybersecurity through innovative data processing and quantum technology integration.

### DESCRIPTION OF THE RELATED ART

In the contemporary landscape of digital systems, the escalation of cyber threats poses a significant challenge to organizations relying on traditional methods for safeguarding their networks. As malicious entities deploy increasingly sophisticated strategies, the volume and complexity of attacks have surged, overwhelming conventional detection mechanisms. These traditional approaches often struggle to keep pace with the evolving nature of intrusions, leaving systems vulnerable to breaches that can compromise sensitive information and disrupt operations. The inability to effectively identify such threats in a timely manner has become a pressing concern for entities managing extensive digital infrastructures.

One of the primary issues stems from the limitations inherent in classical computational frameworks when tasked with processing vast amounts of data generated by modern networks. As data traffic grows exponentially, driven by interconnected devices and expansive communication systems, the sheer scale of information becomes difficult to analyze efficiently. Traditional tools, designed for simpler datasets, falter when confronted with the high-dimensional and intricate patterns characteristic of current network activity. This inadequacy results in delayed or missed detection of irregularities, allowing malicious actions to persist undetected for extended periods.

Moreover, the advent of quantum computing introduces additional layers of complexity to the cybersecurity domain. Quantum-generated data, with its unique properties, presents a formidable obstacle for conventional detection systems. These systems, rooted in classical logic, lack the capacity to interpret or analyze quantum-based information effectively. As quantum technologies become more prevalent, the potential for adversaries to leverage these advancements for nefarious purposes increases, further exposing the deficiencies of outdated methodologies in addressing such emerging threats.

The challenge is compounded by the dynamic nature of cyber intrusions, which often adapt to evade established detection protocols. Traditional approaches rely heavily on predefined signatures or rules to identify known threats, but this method proves insufficient against novel or zero-day attacks. Such attacks, lacking recognizable patterns in existing databases, slip through the defenses of systems unprepared to handle uncharted anomalies. This reactive stance leaves networks perpetually at risk, as defenders scramble to update their tools after an incident has already occurred.

Another dimension of the problem lies in the integrity of data as it traverses networks. Ensuring that information remains unaltered from sender to receiver is a foundational requirement for secure communication. However, traditional verification mechanisms struggle to maintain robustness against sophisticated tampering techniques employed by attackers. The inability to reliably confirm data authenticity undermines trust in digital transactions and exposes systems to manipulation, amplifying the difficulty of distinguishing legitimate activity from malicious interference.

High-dimensional datasets, common in modern network environments, exacerbate these issues by introducing noise and complexity that obscure subtle indicators of intrusions. Classical processing techniques often lack the precision needed to sift through this noise and extract meaningful insights. As a result, faint signals of potential threats are frequently overlooked, buried beneath layers of irrelevant or redundant information. This limitation hinders the ability to achieve comprehensive situational awareness across sprawling digital ecosystems.

Furthermore, the real-time demands of network monitoring add another layer of difficulty. Cyber threats can unfold rapidly, requiring immediate identification to mitigate damage. Traditional systems, burdened by sequential processing and limited computational power, struggle to deliver timely alerts. Delays in detection enable attackers to establish footholds within networks, escalating the potential impact of breaches before defensive measures can be deployed.

The integration of legacy systems into modern infrastructures presents an additional hurdle. Many organizations rely on older technologies that were not designed to contend with contemporary threat landscapes. These systems, while functional for their original purposes, lack the adaptability to address the nuances of current cyber challenges. The disparity between legacy capabilities and modern requirements creates gaps that attackers can target, further complicating efforts to maintain a cohesive defense strategy.

Data transmitted across networks often includes a mix of structured and unstructured formats, each presenting unique analytical challenges. Structured data, such as database entries, may follow predictable patterns, but unstructured data, like multimedia or free-form text, resists standardization. Traditional detection methods, optimized for uniform datasets, falter when tasked with interpreting this diversity, reducing their effectiveness in identifying irregularities across varied data types.

The rise of encrypted communication channels introduces yet another obstacle. While encryption enhances privacy, it also obscures visibility into data flows, making it harder for conventional tools to inspect content for signs of malicious activity. Attackers can target this opacity to conceal their actions, bypassing detection mechanisms that rely on clear access to data payloads. This trend underscores the need for approaches capable of operating effectively in environments where full transparency is not guaranteed.

Latency in processing large datasets further undermines the efficacy of traditional systems. As network traffic scales, the time required to analyze incoming information increases, creating bottlenecks that impede swift responses. In high-stakes scenarios, where every moment counts, this lag can prove catastrophic, allowing threats to proliferate unchecked. The inability to match the speed of data generation with analysis capabilities remains a persistent barrier.

Additionally, the correlation of data points across distributed systems poses a significant challenge. Networks often span multiple nodes, each generating streams of information that must be synthesized to form a complete picture. Classical tools struggle to entangle these disparate sources effectively, missing connections that could reveal coordinated attacks. This fragmentation limits the ability to detect subtle, multi-faceted intrusions that span across infrastructure boundaries.

The unpredictability of attack vectors adds further complexity. Adversaries employ diverse tactics, ranging from overt disruptions to stealthy infiltrations, each requiring distinct detection strategies. Traditional systems, bound by rigid frameworks, lack the flexibility to adapt to this variability, resulting in inconsistent performance. The absence of a unified approach capable of addressing the full spectrum of threats leaves networks exposed to an array of risks.

Compounding these issues is the resource intensity of monitoring expansive networks. Classical methods often demand significant computational power to process data at scale, straining organizational resources. This inefficiency not only hampers detection efforts but also diverts capacity from other operational priorities. The need for a solution that balances effectiveness with resource conservation is increasingly evident as networks continue to grow in size and complexity.

The long-felt and unmet need for a solution to these challenges has persisted as cyber threats have evolved beyond the capabilities of traditional detection systems. For years, organizations have sought a means to address the limitations of classical approaches in handling high-dimensional, quantum-influenced, and rapidly changing data environments. Existing tools have proven inadequate in delivering real-time, adaptable, and comprehensive anomaly detection, leaving a gap that adversaries target with impunity. This enduring demand for an innovative approach underscores the urgency of overcoming the shortcomings of legacy methodologies to protect digital infrastructures in an era of unprecedented technological advancement.

### SUMMARY OF THE INVENTION

The invention centers on a sophisticated framework designed to enhance the detection of anomalies within network data through a hybrid approach that integrates quantum and classical computational techniques. This system leverages a combination of a quantum neural network and a traditional neural network, creating a layered architecture that processes complex datasets with high efficiency. The integration of these two paradigms allows the system to handle diverse data types, including high-dimensional and quantum-generated information, ensuring robust analysis across varied network environments.

At the core of this framework is the Quantum Intrusion Detection Monitor, a pivotal component that orchestrates the anomaly detection process. This monitor operates by receiving data bundled with a quantum-safe digital signature, which is generated by the sender using advanced cryptographic methods. The use of hash-based signature schemes, such as SPHINCS+, ensures that the data's authenticity can be verified before further processing, providing a foundational layer of security that protects against tampering during transmission.

The data acquisition phase begins with the collection of information from users and network traffic, forming the initial input into the system. This raw data, which may include both structured and unstructured formats, is then passed to the Quantum Data Preprocessing layer. Here, the sender employs quantum-resistant hash functions, such as SHA3 or BLAKE2, to generate a hash of the input data. This hash is subsequently signed using a quantum-safe digital signature, ensuring that the data remains intact and verifiable as it moves through the network.

For scenarios involving quantum-based data transfer, the system incorporates quantum key distribution protocols to encode the information. This step leverages quantum encoding techniques to protect the data, utilizing principles like quantum entanglement to secure it against interception or alteration. The encoded data, now fortified with a quantum-safe signature, is transmitted to the next stage of the framework, where it undergoes transformation and analysis.

Upon reaching the Quantum Neural Network-Intrusion Detection Model, the data enters a validation phase to confirm its authenticity and integrity. This model, which can be deployed at the receiver's end or within a centralized monitoring gateway, employs a preprocessing layer known as the Quantum Feature Map. In this layer, classical data is normalized and converted into a quantum state using amplitude encoding, a technique suited for large datasets that transforms the information into qubits for quantum processing.

The conversion process involves entangling the qubits using controlled NOT gates, a method that establishes correlations within the data. This entanglement enhances the system's ability to identify subtle relationships and patterns, which are essential for detecting anomalies that might otherwise go unnoticed. By mapping the data into a quantum state, the framework prepares it for deeper analysis within the subsequent layers of the neural network.

Feature extraction follows as a critical step, where the quantum data is processed to assess its integrity and uncover meaningful transformations. The system employs variational quantum circuits, which apply parametrized quantum gates and rotational circuits to manipulate the quantum states. These circuits enable the framework to learn and optimize data representations, adapting to the unique characteristics of the input and refining its ability to discern patterns indicative of potential threats.

The variational quantum circuits operate through a process of approximation and optimization, iteratively adjusting the quantum states to enhance the accuracy of anomaly detection. This adaptability allows the system to handle the dynamic nature of network data, where patterns may shift rapidly due to varying conditions or emerging threats. By transforming the data into meaningful representations, the framework sets the stage for precise classification.

Anomaly identification is achieved through the use of a Variational Quantum Recurrent Network, a specialized component that leverages quantum memory to track changes in data states over time. This network stores historical states, enabling it to detect deviations that signal irregularities or intrusions. By maintaining a quantum memory of previous data configurations, the system can compare current inputs against past patterns, improving its sensitivity to subtle anomalies.

The interplay between quantum entanglement and pattern recognition further strengthens the framework's detection capabilities. Quantum entanglement allows the system to trace correlations across the dataset, revealing interconnected anomalies that might span multiple data points. This capability is particularly valuable in distributed network environments, where threats may manifest across disparate nodes.

Once anomalies are identified, the system generates alerts to notify relevant parties, enabling swift responses to potential threats. This real-time alerting mechanism ensures that irregularities are addressed promptly, minimizing the window of opportunity for malicious actions to escalate. The receiver, upon receiving the data, recomputes the hash and validates the quantum-safe signature, confirming end-to-end integrity and closing the loop of the detection process.

A unique aspect of the invention lies in its hybrid architecture, which seamlessly bridges quantum and classical neural networks through a multi-translation layer. This layer facilitates communication between the two systems, allowing the framework to leverage the strengths of both paradigms. The quantum neural network excels at processing quantum states and high-dimensional data, while the classical neural network provides stability and compatibility with legacy systems.

The multi-translation layer serves as an intermediary, converting outputs from the quantum neural network into formats that the classical neural network can process, and vice versa. This bidirectional integration ensures that the system remains versatile, capable of operating within modern quantum-enabled environments as well as traditional infrastructures. The hybrid approach thus extends the framework's applicability across a wide range of network configurations.

Another distinctive feature is the use of amplitude encoding for large datasets, a choice that optimizes the transformation of classical data into quantum states. This encoding method, paired with entanglement via CNOT gates, maximizes the system's ability to handle voluminous and complex information. For time-series datasets, the framework can also employ angle encoding, demonstrating its flexibility in adapting to different data characteristics.

The incorporation of quantum-safe cryptography, such as the SPHINCS+ signature scheme, represents a forward-thinking approach to security. This stateless hash-based signature method provides resilience against quantum computing threats, ensuring that the system remains effective even as cryptographic landscapes evolve. Libraries like liboqs can be utilized to implement these signatures, streamlining their integration into the framework.

The variational quantum circuits and recurrent network components contribute to the system's learning capabilities, enabling it to refine its detection accuracy over time. By optimizing quantum states through iterative training, the framework adapts to new patterns and anomalies, maintaining relevance in the face of shifting network dynamics. This self-improving mechanism enhances the system's longevity and effectiveness.

The layered protection offered by the framework is a key strength, combining quantum data preprocessing, signature verification, and neural network analysis into a cohesive defense strategy. Each layer builds upon the previous one, creating a robust pipeline that addresses multiple facets of anomaly detection. This multi-tiered design ensures comprehensive coverage, from data acquisition to alert generation.

The system's ability to operate in real-time is facilitated by its quantum-enhanced processing, which reduces latency compared to traditional methods. By leveraging the parallelism inherent in quantum computing, the framework can analyze large datasets swiftly, meeting the demands of high-speed network environments. This efficiency is critical for applications where timely detection is paramount.

The invention also stands out for its potential compatibility with centralized monitoring gateways, offering scalability for enterprise-level deployments. Whether implemented at the receiver's end or as a network-wide solution, the framework can be tailored to suit organizational needs. This adaptability, combined with its advanced technological foundation, positions the system as a versatile tool for enhancing network security.

In light of the preceding discussion, the following offers a streamlined summary of the present disclosure to provide a foundational understanding of its various components. This summary is not comprehensive, nor does it constrain the illustrative embodiments of the inventions outlined within this document. Its purpose is neither to highlight the most essential or pivotal features or steps of the disclosure, nor to establish its boundaries. Instead, it aims, as would be appreciated by someone well-versed in the field, to present certain concepts of the disclosure in a straightforward manner, serving as an introduction to the more in-depth explanation that follows. Throughout this application, the specification provides ample written descriptions of the inventions, encompassing exemplary, non-exhaustive, and non-restrictive methods and processes for creating and utilizing the inventions. These descriptions are articulated in complete, clear, concise, and precise language, enabling those skilled in the art to implement and apply the inventions without excessive trial and error, while also outlining the optimal approach envisioned for executing the inventions.

In some arrangements, a method for detecting anomalies in network data using a hybrid quantum-classical framework comprises multiple steps performed by distinct components. A data acquisition module acquires raw data from user inputs and network traffic to form a raw dataset. Subsequently, a quantum data preprocessing module preprocesses the raw dataset to generate a quantum-safe signed dataset by applying a quantum-resistant hash function to produce a data hash and signing the data hash with a quantum-safe digital signature scheme. Following this, a quantum encoding module encodes the quantum-safe signed dataset into a quantum-encoded dataset using a quantum key distribution protocol when the raw dataset is designated for quantum transfer. The quantum encoding module also entangles qubits of the quantum-encoded dataset using a controlled NOT gate to produce an entangled quantum dataset.

In some arrangements, the method continues with a validation layer of a quantum neural network-intrusion detection model validating the integrity and authenticity of the quantum-safe signed dataset or the entangled quantum dataset to produce a validated dataset. A quantum feature map layer of the quantum neural network-intrusion detection model then converts the validated dataset into a quantum state dataset by normalizing the validated dataset and applying amplitude encoding, and it further entangles qubits of the quantum state dataset using a controlled NOT gate to produce an entangled quantum state dataset. Next, a feature extraction layer of the quantum neural network-intrusion detection model extracts quantum features from the entangled quantum state dataset using variational quantum circuits with parametrized rotational gates and optimizes the quantum features using a gradient descent optimizer to produce optimized quantum features.

In some arrangements, a variational quantum recurrent network of the quantum neural network-intrusion detection model identifies anomalies in the optimized quantum features by storing historical states in a quantum memory and classifying the optimized quantum features against the historical states to generate anomaly scores, and it thresholds the anomaly scores against a predefined threshold to identify detected anomalies. An alert generation module generates alerts based on the detected anomalies. Concurrently, a classical neural network processes the raw dataset to produce a classical output. A multi-translation layer translates the optimized quantum features into a classical format to produce a translated classical output and translates the classical output into a quantum format to produce a translated quantum input. Finally, an integration module integrates the translated classical output and the alerts to produce a final result.

In some arrangements, the method described previously is refined such that the quantum data preprocessing module further preprocesses the raw dataset to generate the quantum-safe signed dataset by using SHA3 as the quantum-resistant hash function to produce the data hash.

In some arrangements, the method builds on the prior refinement by having the quantum data preprocessing module further preprocess the raw dataset to generate the quantum-safe signed dataset by using SPHINCS+ as the quantum-safe digital signature scheme to sign the data hash produced by the SHA3 quantum-resistant hash function.

In some arrangements, the method extends the previous steps such that the quantum encoding module further encodes the quantum-safe signed dataset into the quantum-encoded dataset by implementing a BB84 protocol as the quantum key distribution protocol to generate a quantum key for encryption when the raw dataset is designated for quantum transfer.

In some arrangements, the method progresses from the earlier description by having the feature extraction layer of the quantum neural network-intrusion detection model further extract quantum features from the entangled quantum state dataset by configuring the variational quantum circuits with RY and RZ rotational gates to transform the entangled quantum state dataset.

In some arrangements, the method enhances the prior steps such that the variational quantum recurrent network of the quantum neural network-intrusion detection model further identifies anomalies in the optimized quantum features by setting the predefined threshold to 0.9 to distinguish the detected anomalies from the anomaly scores.

In some arrangements, the method advances the previous arrangement by having the alert generation module further generate alerts based on the detected anomalies and assign a severity rank to each of the alerts based on a magnitude of a corresponding anomaly score among the anomaly scores.

In some arrangements, the method builds upon the earlier steps such that the classical neural network further processes the raw dataset by utilizing a convolutional neural network to analyze spatial patterns in the raw dataset and produce the classical output.

In some arrangements, the method refines the prior description by having the multi-translation layer further translate the optimized quantum features into the classical format to produce the translated classical output and translate the classical output into the quantum format to produce the translated quantum input, wherein the translating includes applying feature fusion to the optimized quantum features and the classical output during translation to enhance the translated classical output and the translated quantum input.

In some arrangements, the method extends the previous steps such that the integration module further integrates the translated classical output and the alerts to produce the final result and logs the detected anomalies and the final result into a persistent storage system for subsequent analysis.

In some arrangements, a system for detecting anomalies in network data using a hybrid quantum-classical framework comprises several configured components. A data acquisition module is configured to acquire raw data from user inputs and network traffic to form a raw dataset. A quantum data preprocessing module is configured to preprocess the raw dataset to generate a quantum-safe signed dataset by applying a quantum-resistant hash function to produce a data hash and signing the data hash with a quantum-safe digital signature scheme. A quantum encoding module is configured to encode the quantum-safe signed dataset into a quantum-encoded dataset using a quantum key distribution protocol when the raw dataset is designated for quantum transfer and to entangle qubits of the quantum-encoded dataset using a controlled NOT gate to produce an entangled quantum dataset.

In some arrangements, the system includes a quantum neural network-intrusion detection model with multiple layers. A validation layer is configured to validate the integrity and authenticity of the quantum-safe signed dataset or the entangled quantum dataset to produce a validated dataset. A quantum feature map layer is configured to convert the validated dataset into a quantum state dataset by normalizing the validated dataset and applying amplitude encoding, and to entangle qubits of the quantum state dataset using a controlled NOT gate to produce an entangled quantum state dataset. A feature extraction layer is configured to extract quantum features from the entangled quantum state dataset using variational quantum circuits with parametrized rotational gates and to optimize the quantum features using a gradient descent optimizer to produce optimized quantum features.

In some arrangements, the quantum neural network-intrusion detection model further includes a variational quantum recurrent network configured to identify anomalies in the optimized quantum features by storing historical states in a quantum memory and classifying the optimized quantum features against the historical states to generate anomaly scores, and to threshold the anomaly scores against a predefined threshold to identify detected anomalies. An alert generation module is configured to generate alerts based on the detected anomalies. A classical neural network is configured to process the raw dataset to produce a classical output. A multi-translation layer is configured to translate the optimized quantum features into a classical format to produce a translated classical output and to translate the classical output into a quantum format to produce a translated quantum input. An integration module is configured to integrate the translated classical output and the alerts to produce a final result.

In some arrangements, the system described previously is enhanced such that the quantum data preprocessing module is further configured to preprocess the raw dataset to generate the quantum-safe signed dataset by using SHA3 as the quantum-resistant hash function to produce the data hash.

In some arrangements, the system builds on the prior enhancement by having the quantum data preprocessing module further configured to preprocess the raw dataset to generate the quantum-safe signed dataset by using SPHINCS+ as the quantum-safe digital signature scheme to sign the data hash produced by the SHA3 quantum-resistant hash function.

In some arrangements, the system extends the previous configuration such that the quantum encoding module is further configured to encode the quantum-safe signed dataset into the quantum-encoded dataset by implementing a BB84 protocol as the quantum key distribution protocol to generate a quantum key for encrypting the quantum-safe signed dataset into the quantum-encoded dataset when the raw dataset is designated for quantum transfer.

In some arrangements, the system advances the earlier setup by having the feature extraction layer of the quantum neural network-intrusion detection model further configured to extract quantum features from the entangled quantum state dataset by configuring the variational quantum circuits with RY and RZ rotational gates to transform the entangled quantum state dataset into the quantum features.

In some arrangements, the system refines the prior arrangement such that the variational quantum recurrent network of the quantum neural network-intrusion detection model is further configured to identify anomalies in the optimized quantum features by setting the predefined threshold to 0.9 to distinguish the detected anomalies from the anomaly scores.

In some arrangements, the system builds upon the previous configuration by having the alert generation module further configured to generate alerts based on the detected anomalies and assign a severity rank to each of the alerts based on a magnitude of a corresponding anomaly score among the anomaly scores.

In some arrangements, the system extends the earlier description such that the classical neural network is further configured to process the raw dataset by utilizing a convolutional neural network to analyze spatial patterns in the raw dataset and produce the classical output.

In some arrangements, the system enhances the prior steps by having the multi-translation layer further configured to translate the optimized quantum features into the classical format to produce the translated classical output and translate the classical output into the quantum format to produce the translated quantum input, wherein the multi-translation layer is configured to apply feature fusion to the optimized quantum features and the classical output during translation to enhance the translated classical output and the translated quantum input.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary technical flow diagram in accordance with one or more embodiments disclosed herein that illustrates the sequential process of detecting anomalies in network data using a hybrid quantum-classical framework. It details the steps from data acquisition and quantum-safe preprocessing on the sender side to quantum neural network-based interruption detection and validation on the receiver side, highlighting key stages and their interactions.

FIG. 2 is an exemplary system architecture diagram in accordance with one or more embodiments disclosed herein that illustrates a hybrid quantum-classical framework for detecting anomalies in network data. It depicts a detailed arrangement of components, including quantum-safe preprocessing, quantum neural network processing, classical neural network analysis, and integrated alert generation, interconnected to transform raw data into actionable anomaly detection outputs.

FIG. 3 is an exemplary sequence diagram in accordance with one or more embodiments disclosed herein that illustrates the interactions between actors in a hybrid quantum-classical framework for detecting anomalies in network data. It details the step-by-step flow from data acquisition and quantum-safe preprocessing through quantum neural network analysis, classical neural network processing, and integrated alert generation, capturing the invention's core operational sequence.

FIG. 4 is an exemplary class diagram in accordance with one or more embodiments disclosed herein that illustrates the object-oriented design of a hybrid quantum-classical framework for detecting anomalies in network data. It details the classes, attributes, methods, and interconnections across three parts—data acquisition and preprocessing, quantum neural network processing, and classical processing with integration—capturing the invention's core functionalities and components.

### DETAILED DESCRIPTION

The invention presents a sophisticated hybrid quantum-classical framework designed to detect anomalies in network data, integrating advanced quantum computing techniques with traditional classical methods to address the escalating challenges of cybersecurity in modern digital environments. At its core, the system leverages a combination of quantum neural networks and classical neural networks to process complex datasets, identifying irregularities that could indicate potential threats such as intrusions or data tampering. This dual approach capitalizes on the strengths of quantum computing—such as its ability to handle high-dimensional and quantum-generated data—while retaining the reliability and compatibility of classical systems, making it a versatile solution for diverse network infrastructures.

The process begins with data acquisition, where raw data from user inputs and network traffic is collected to form a comprehensive dataset. User inputs might include login attempts, file uploads, or system commands, while network traffic encompasses packets, requests, and streaming data, ensuring a broad capture of network activity. This initial step establishes the foundation for subsequent processing, gathering both structured data like database records and unstructured data such as video or text logs, which are critical for a thorough analysis of network behavior.

Following data collection, the invention employs a quantum data preprocessing module to secure the raw dataset before transmission. This module applies a quantum-resistant hash function, specifically SHA3, to generate a data hash, transforming the data into a compact, integrity-preserving format. SHA3's design, based on the Keccak sponge construction, ensures resilience against quantum attacks, providing a robust first layer of security that protects the data's core identity during classical transmission scenarios.

To further enhance security, the preprocessing module signs the data hash with the SPHINCS+ quantum-safe digital signature scheme, a hash-based method that uses Merkle trees to create a signature. This signature, attached to the hash, guarantees non-repudiation and allows the receiver to verify the data's authenticity and integrity, detecting any tampering that might occur en route. The use of SPHINCS+ reflects a forward-thinking approach, anticipating future quantum computing threats while ensuring current robustness.

For datasets designated for quantum transfer, the invention incorporates a quantum encoding module that encrypts the signed dataset using a quantum key distribution protocol, specifically BB84. This protocol generates a quantum key through photon polarization states, which is then used to encode the data into a quantum state, offering protection against interception due to the principles of quantum mechanics, such as the no-cloning theorem. The encoded dataset undergoes entanglement via a controlled NOT (CNOT) gate, linking qubits to establish correlations that enhance subsequent analysis.

The quantum-encoded or signed dataset then enters the quantum neural network intrusion detection model, a central component that orchestrates the anomaly detection process. This model first validates the dataset's integrity and authenticity by recomputing the hash and verifying the SPHINCS+ signature, ensuring that only untampered data proceeds. This validation step mirrors the preprocessing security measures, reinforcing end-to-end integrity across the system.

Once validated, the dataset is transformed into a quantum state dataset through a quantum feature map layer, which normalizes the data and applies amplitude encoding to convert it into qubit amplitudes. Normalization adjusts the data to a standard range, facilitating quantum processing, while amplitude encoding maps values to quantum states, enabling the system to leverage quantum parallelism. The qubits are entangled again using a CNOT gate, further strengthening correlations for feature extraction.

The feature extraction layer processes the entangled quantum state dataset using variational quantum circuits equipped with parametrized rotational gates, specifically RY and RZ gates. These circuits transform the quantum states to detect patterns, with parameters adjusted via a gradient descent optimizer to refine the extracted features. This optimization ensures that the features accurately represent the data's underlying structure, enhancing the system's ability to identify anomalies.

A variational quantum recurrent network within the detection model identifies anomalies by storing historical states in a quantum memory and classifying the optimized features against these states to generate anomaly scores. The quantum memory retains past data configurations, allowing temporal analysis, while the classification produces scores that indicate potential irregularities (e.g., a score of 0.95 suggesting a significant anomaly). These scores are thresholded at 0.9, flagging detected anomalies for further action.

The alert generation module creates alerts based on the detected anomalies, assigning a severity rank to each alert according to the anomaly score's magnitude. For instance, a score of 0.95 might yield a “High” severity alert, signaling a critical issue like a DDoS attack, while a lower score might indicate normal behavior. This ranking system prioritizes responses, ensuring timely attention to significant threats.

Parallel to the quantum processing, the invention employs a classical neural network to analyze the raw dataset, utilizing a convolutional neural network component to extract spatial patterns, such as packet sequence regularities. This classical output complements the quantum analysis, providing a dual perspective that enhances overall detection accuracy, especially for scenarios where classical methods excel, like structured data analysis.

The multi-translation layer bridges the quantum and classical outputs, translating quantum features into a classical format and classical outputs into a quantum format, then applying feature fusion to combine these translated elements. This fusion enhances the integrated data representation, merging quantum-derived features (e.g., variance) with classical insights (e.g., packet rates), creating a unified dataset for final processing.

The integration module consolidates the translated classical output and alerts into a final result, adjusting the variational quantum circuit depth based on dataset complexity and monitoring the quantum neural network's latency to scale processors for real-time performance. This dynamic adaptability ensures efficiency, adding circuit layers for complex data or increasing quantum resources if latency exceeds thresholds (e.g., 1 ms), maintaining operational speed.

Finally, the persistent storage system logs the detected anomalies and final result, storing data like “score:0.95, type: DDoS” in a database for subsequent analysis, enabling historical tracking and system refinement. This comprehensive storage supports forensic investigations and performance tuning, completing the invention's end-to-end process from data acquisition to actionable outcomes.

The explanation of the various example embodiments presented here is designed to fulfill the objectives previously mentioned, drawing on the illustrations provided within this disclosure. These illustrations showcase a variety of systems and methods for putting the disclosed concepts into practice. It is understood that different approaches to implementation are feasible, and adjustments to both the structure and operation of these systems and methods are permissible. The description elaborates on numerous connections among components, which should be understood in a flexible sense. Unless specifically noted otherwise, such connections may be direct or indirect and can be facilitated through either wired or wireless means. This document is not intended to limit the form or type of these connections.

The hybrid quantum-classical framework for detecting anomalies in network data, as outlined in the invention, leverages several types of artificial intelligence (AI) to implement its various aspects. These AI types include machine learning, deep learning, quantum machine learning, and recurrent neural networks. Each type contributes uniquely to the system's ability to process data, extract features, identify anomalies, and generate actionable alerts, enhancing the invention's effectiveness in cybersecurity applications. Below is a detailed exploration of each applicable AI type, its definition, its relevance to specific aspects of the invention, and examples of implementations that could be utilized.

Machine learning is a broad category of AI that involves training algorithms to make predictions or decisions based on data without explicit programming for each task. It relies on statistical techniques to identify patterns and relationships within datasets, adapting to new information through iterative training. In the invention, machine learning applies to the anomaly detection process, particularly in the preprocessing and classification stages. The Quantum Data Preprocessing Module (402) and Classical Neural Network (440) can use machine learning to preprocess raw data and classify anomalies by learning normal network behavior patterns from historical data, then flagging deviations as potential threats. For example, a supervised machine learning algorithm like a Support Vector Machine (SVM) could be trained on labeled network traffic data (e.g., “normal” vs. “intrusion”) to classify incoming packets, while an unsupervised method like K-Means clustering could group similar traffic patterns, identifying outliers as anomalies (e.g., clustering “size:1024, rate:100 pkt/s” vs. “size:5000, rate:1000 pkt/s”). These algorithms could enhance the initial data hashing and classical output generation, providing a baseline for anomaly scoring.

Deep learning, a subset of machine learning, utilizes neural networks with multiple layers to model complex, non-linear relationships in data. It excels at processing large, unstructured datasets, extracting hierarchical features through layers of interconnected nodes that mimic human neural processing. In the invention, deep learning is directly applicable to the Classical Neural Network (440) and its Convolutional Neural Network Component (442), which analyze spatial patterns in the raw dataset. This capability allows the system to detect subtle anomalies in network traffic, such as irregular packet sequences or unusual data distributions, by learning intricate patterns that simpler models might miss. An example implementation is a Convolutional Neural Network (CNN) built in TensorFlow, trained on network packet images (e.g., visualized as 2D arrays of “source IP, timestamp, size”) to identify spatial anomalies like sudden traffic spikes indicative of a DDoS attack (e.g., “rate:100 pkt/s” shifting to “rate:1000 pkt/s”). Another example is a Deep Belief Network (DBN) for unsupervised feature extraction, processing unstructured logs (e.g., “POST/login, user: admin”) to uncover hidden patterns for anomaly detection.

Quantum machine learning extends machine learning by incorporating quantum computing principles, such as superposition, entanglement, and interference, to process data in ways classical systems cannot. It uses quantum algorithms to perform computations on quantum states, potentially offering exponential speedups for specific tasks like optimization and pattern recognition. This type of AI is central to the Quantum Neural Network Intrusion Detection Model (414), particularly in the Feature Extraction Layer (426), Variational Quantum Circuits Component (424), and Gradient Descent Optimizer Component (428). These components extract and optimize quantum features from the entangled quantum state dataset, leveraging quantum parallelism to handle high-dimensional data efficiently. For instance, a Quantum Support Vector Machine (QSVM) implemented in Qiskit could classify quantum-encoded network data (e.g., |ψ>=0.125|000>+0.992|111>) by finding an optimal hyperplane in a quantum feature space, detecting anomalies like protocol violations. Another example is a Variational Quantum Classifier (VQC), using variational circuits with RY and RZ gates (e.g., RY(θ=π/4)) to learn patterns in quantum states, optimizing parameters via gradient descent to flag irregularities (e.g., variance shift from 0.1 to 0.8), aligning with the invention's quantum feature extraction and optimization processes.

Recurrent neural networks (RNNs) are a specialized form of deep learning designed to process sequential or time-series data by maintaining a memory of previous inputs through recurrent connections. They are particularly effective for tasks involving temporal dependencies, allowing the model to learn from the order and context of data points. In the invention, RNNs are applicable to the Variational Quantum Recurrent Network (430) and Quantum Memory Component (432), which identify anomalies by storing and classifying historical states of optimized quantum features. This temporal analysis capability enables the system to detect anomalies that evolve over time, such as gradual increases in traffic indicative of a slow attack. A classical RNN example is a Long Short-Term Memory (LSTM) network in Keras, trained on time-series traffic data (e.g., “rate:100 pkt/s at t=1, 150 pkt/s at t=2, 1000 pkt/s at t=3”) to predict anomalies by remembering past rates, flagging “1000 pkt/s” as unusual. In the quantum domain, a Quantum RNN implemented in Qiskit could use recurrent quantum circuits to store states (e.g., |ψ_t−1>, |ψ_t> in a 10-qubit register), classifying sequences (e.g., “rate:100 pkt/s” to “rate:1000 pkt/s”) with scores (e.g., 0.95), thresholding at 0.9 to generate alerts, directly supporting the invention's anomaly identification and memory storage.

Each of these AI types integrates into the invention's framework to address specific aspects, enhancing its overall anomaly detection capability. Machine learning provides foundational pattern recognition and classification, preprocessing raw data into a usable form and identifying baseline anomalies in the Classical Neural Network (440). Deep learning, through convolutional neural networks, refines this analysis by extracting complex spatial features from network traffic, offering a classical counterpart to quantum processing. Quantum machine learning, pivotal to the Quantum Neural Network Intrusion Detection Model (414), harnesses quantum advantages to process high-dimensional, quantum-encoded data, optimizing features for anomaly detection with variational circuits and gradient descent. Recurrent neural networks, both classical and quantum, enable temporal analysis within the Variational Quantum Recurrent Network (430), tracking data evolution to detect sequential anomalies, supported by quantum memory for historical state retention.

Examples of these AI implementations demonstrate their practical utility. A machine learning SVM could run on a Python scikit-learn platform, training on labeled datasets (e.g., “normal: 100 pkt/s, anomaly: 1000 pkt/s”) to classify real-time traffic. A TensorFlow CNN could process packet visualizations (e.g., 2D arrays of “IP, size”) to detect spatial irregularities, such as a sudden cluster of high-sized packets. A Qiskit QSVM could operate on quantum hardware, classifying entangled states (e.g., |ψ> representing “rate:1000 pkt/s”) with quantum kernels, while a VQC could optimize circuit parameters (e.g., θ, φ) to pinpoint anomalies like traffic spikes. An LSTM in Keras could analyze sequential logs (e.g., “t=1:100 pkt/s, t=2:1000 pkt/s”), and a Quantum RNN in Qiskit could classify quantum state sequences (e.g., |ψ_t>), both thresholding at 0.9 to trigger alerts (e.g., “High: DDoS”).

These AI types collectively enable the invention to process diverse data types—structured and unstructured, classical and quantum—across multiple stages, from preprocessing to anomaly detection and alert generation. Machine learning and deep learning handle classical data efficiently, quantum machine learning tackles quantum-encoded data with computational advantages, and recurrent neural networks provide temporal context, ensuring comprehensive anomaly detection. This integration reflects the invention's unique hybrid approach, combining classical reliability with quantum innovation to address modern cybersecurity challenges.

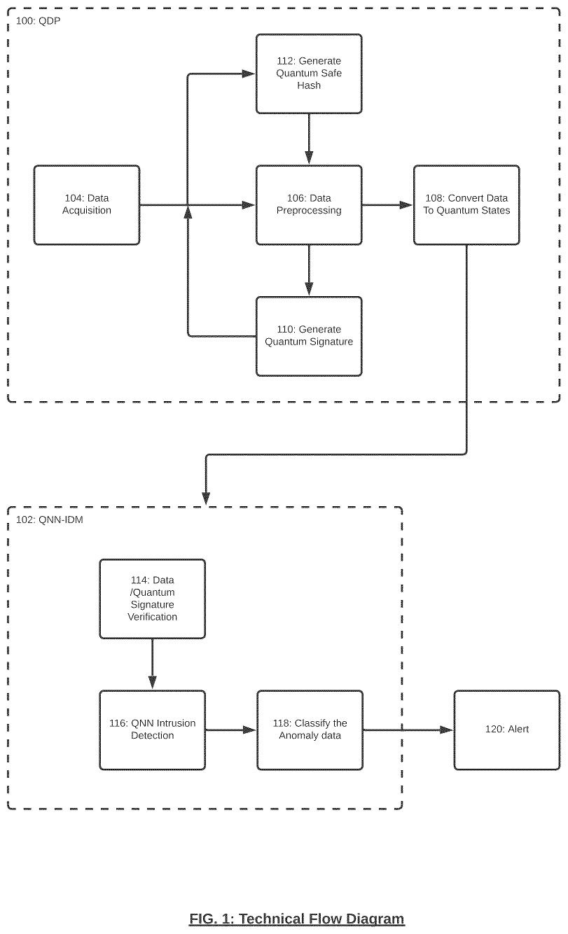

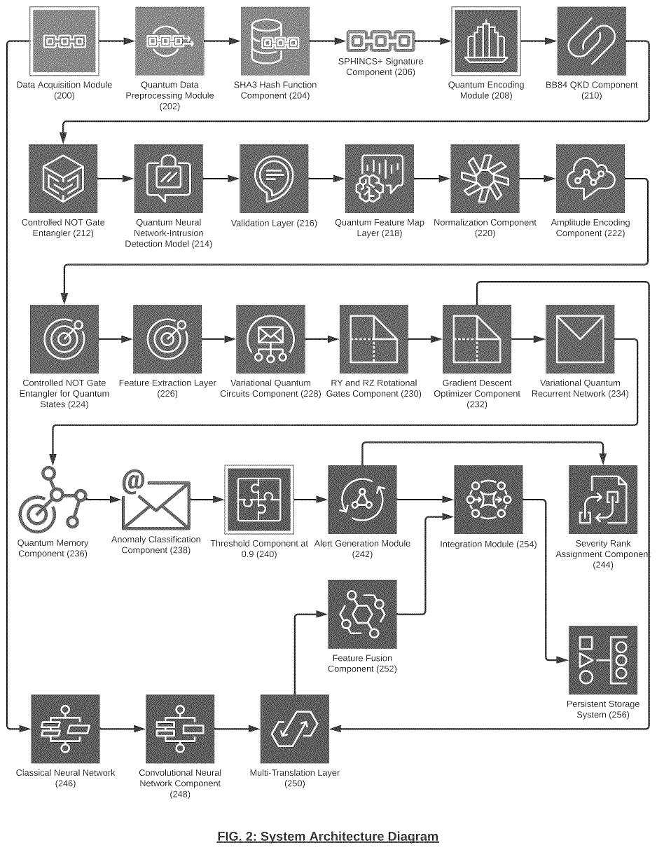

FIG. 1, a Technical Flow Diagram, presents a detailed visual representation of a system designed to detect anomalies in network data through a hybrid quantum-classical framework, as outlined in the accompanying text provided on the drawing. This diagram maps out the steps and components—identified with numbers in parentheses using the format QDP (100) through Alert (120)—involved in transforming raw data from collection to anomaly detection, integrating quantum and classical methodologies to enhance security, accuracy, and efficiency.

QDP (100) stands for Quantum Data Preprocessing, the sender-side preprocessing phase of the system where raw data is secured and prepared for transmission. This component includes sub-processes that ensure data integrity and authenticity before sending it to the receiver or a centralized monitoring gateway. QDP (100) transforms raw data into a quantum-safe signed dataset or a quantum-encoded dataset, depending on the transmission type, using quantum-resistant cryptographic techniques to protect against tampering and ensure non-repudiation. This module combines classical and quantum preprocessing methods, forming the first step in securing data for anomaly detection.

Within QDP (100), Data Acquisition (104) is the sub-component that collects raw data from user inputs and network traffic. This part gathers data from sources like login credentials, file uploads, system commands, TCP/IP packets, HTTP requests, and real-time streaming data, forming the raw dataset for downstream processes. Data Acquisition (104) captures structured data, such as database records or XML files, and unstructured data, like video feeds, audio clips, or text logs, creating a comprehensive dataset. Implementation uses network sniffers like Wireshark to monitor traffic, capturing packet headers (e.g., source IP: 192.168.1.1, destination IP: 10.0.0.1, port: 80), and APIs or SDKs to collect user inputs from applications (e.g., REST API calls logging “POST/login, user: admin”), storing data in a buffer like a Redis queue. An example includes aggregating a user's file upload (“file: document. pdf, size:5 MB”) with network packets (e.g., “SYN, ACK, payload: 1024 bytes”) into a JSON dataset: {“user_data”: {“file”: “document.pdf”}, “traffic”: {“source”: “192.168.1.1”}}.

Generate Quantum Safe Hash (112) within QDP (100) corresponds to “For Classical structured/unstructured data transmission: Quantum-safe hash function(SHA3/BLAKE2) to generate hash for input data.” This sub-component processes the raw dataset from Data Acquisition (104) to produce a secure hash, ensuring data integrity for classical transmission. Generate Quantum Safe Hash (112) uses SHA3, based on the Keccak sponge construction, or BLAKE2, optimized for performance, to transform the data into a fixed-length hash value. Implementation involves a Python script using the hashlib library (e.g., hashlib. sha3_256(json. dumps(data)). hexdigest()) or a C++ module with BLAKE2b, hashing a dataset like {“user”: “admin”, “packet”: “192.168.1.1”} into a 256-bit string (e.g., “a1b2c3d4e5f 6 . . . ”). An example hashes a log entry “timestamp:2025-03-04T10:00, size:1024” into “7f8e9d . . . ”, ensuring any alteration (e.g., size:1025) changes the hash to “9a0b1c . . . ”, detectable at the receiver.

Data Preprocessing (106) within QDP (100) coordinates sub-steps like hashing and signing, not explicitly labeled beyond the QDP context. This sub-component ensures the raw dataset undergoes systematic preparation. Data Preprocessing (106) normalizes data ranges (e.g., scaling packet sizes from 0-65535 bytes to 0-1) before hashing, using a pipeline in TensorFlow or NumPy (e.g., data_normalized=(data−min(data))/(max(data)−min(data))). An example cleans a network stream like {“timestamp”: 12345, “size”: 1024} of noise (e.g., removes duplicate packets via deduplication) and formats it into a schema {“time”: 0.5, “size”: 0.0156} before feeding into Generate Quantum Safe Hash (112), ensuring compatibility with cryptographic processes across data types like text logs or binary streams.

Generate Quantum Signature (110) within QDP (100) aligns with “Quantum Signature Generator: Sender hashes the input using quantum resistant hash function then signs the hashed message using Quantum Digital Signature to ensure non-repudiation” and “Quantum-Safe digital Signature scheme, SPHINCS+ a hash-based signature for strong security and will be attached to the data.” This sub-component takes the hash from Generate Quantum Safe Hash (112) and signs it with SPHINCS+, producing a quantum-safe signed dataset. Generate Quantum Signature (110) uses SPHINCS+, a hash-based signature scheme with Merkle trees, to attach a signature to the hash. Implementation employs the liboqs library in C (e.g., sphincs_sign(hash, private_key, &signature)), attaching a signature to a hash like “a1b2c3d4e5f6 . . . ” to form a signed dataset like “data:a1b2c3 . . . , sig:xyz123abc456 . . . ”. An example signs a hash of “user: admin, ip:192.168.1.1” with a 256-byte SPHINCS+ signature, verifiable at the receiver with the sender's public key (e.g., sphincs_verify(hash, sig, public_key)), confirming identity and detecting tampering if altered to “user: hacker”.

Convert Data To Quantum States (108) within QDP (100) corresponds to “For Quantum based transfer: Quantum encoding is required to protect the data using QKD,” transforming the signed dataset into a quantum-encoded form. This sub-component encrypts the signed dataset with a key from Quantum Key Distribution (QKD), such as the BB84 protocol, encoding bits into qubit states. Implementation uses a quantum simulator like Qiskit, encrypting a signed dataset (e.g., “data:a1b2c3 . . . , sig:xyz123 . . . ”) with a BB84 key (e.g., “101010 . . . ”) into qubit states (|0>for 0, |1> for 1) transmitted via a quantum channel like fiber optics with a photon source (e.g., laser emitting polarized photons at 1 MHz). An example encodes a packet “size:1024, sig:abc123 . . . ” into 1024 qubits (|ψ>=|0>|1>|0> . . . ), entangled via CNOT gates (e.g., control qubit |0>, target qubit |1>→|11>), protecting it against interception due to quantum measurement disturbance (e.g., error rates >25% indicate eavesdropping).

QNN-IDM (102) stands for Quantum Neural Network-Interruption Detection Model, the receiver-side or centralized gateway phase where data is analyzed for anomalies. This component processes the incoming dataset from QDP (100) using quantum neural networks, classical validation, and alerting, with sub-components Data/Quantum Signature Verification (114) through Alert (120). QNN-IDM (102) leverages quantum memory and variational circuits to detect intrusions, adapting to edge devices (e.g., routers) or central hubs (e.g., data centers), forming the analytical core of the system.

Within QNN-IDM (102), Data/Quantum Signature Verification (114) aligns with “Data Validation: Data Authenticity and Data integrity is validated” and “Finally, the receiver recomputes the hash on the received data and validates.” This sub-component verifies the quantum-safe signed dataset from Generate Quantum Signature (110) or the entangled quantum dataset from Convert Data To Quantum States (108). Data/Quantum Signature Verification (114) recomputes the hash and checks the signature to ensure integrity and authenticity. Implementation uses a Python script (e.g., recomputed_hash=hashlib. sha3_256(received_data). hexdigest( ); is_valid=(recomputed_hash==received_hash) and sphincs_verify(recomputed_hash, received_sig, public_key)), validating “data:a1b2c3 . . . , sig:xyz123 . . . ”. An example verifies a packet “size:1024, sig:abc123 . . . ” recomputing to “7f8e9d . . . ” against “7f8e9d . . . , sig:abc123 . . . ” with the sender's public key, rejecting tampered data (e.g., “size:1025”→“9a0b1c . . . ”), ensuring end-to-end integrity.

QNN Intrusion Detection (116) within QNN-IDM (102) corresponds to “Pre-processing layer/Quantum Feature Map layer” and “Feature extraction,” processing validated data into quantum features. This sub-component normalizes the data, encodes it into quantum states using amplitude encoding, entangles qubits with CNOT gates, and extracts features with variational quantum circuits using parametrized gates (RY/RZ). Implementation uses Qiskit to normalize packet data (e.g., size:1024→0.0156 via min-max scaling), encode into qubits (|ψ>=0.125|000>+0.992|111>), entangle with CNOT (e.g., |00>→|11>), and apply RY/RZ gates (e.g., RY(θ=π/4), RZ(φ=π/2)) to extract features like traffic patterns, optimized via gradient descent (e.g., minimize cost=Σ(y_pred−y_true)²). An example detects a 10× traffic spike (rate:1000 pkt/s vs. 100 pkt/s) as an anomaly feature.

Classify the Anomaly Data (118) within QNN-IDM (102) aligns with “Identify Anomaly: Variational Quantum Recurrent Network is used to store the all the states of the data that leverages quantum memory to detect anomaly detection and data integrity verification.” This sub-component stores states in quantum memory and classifies features with a variational quantum recurrent network (VQRN), thresholding scores to identify anomalies. Implementation uses Qiskit, storing states in a 10-qubit register (e.g., past traffic states), classifying with RY(θ) on entangled qubits, and thresholding at 0.9 (e.g., score=0.95>0.9→anomaly). An example flags “rate:1000 pkt/s, variance:0.8” against “rate:100 pkt/s, variance:0.1” as a DDoS attack, while “rate:110 pkt/s” scores 0.2 (normal).

Alert (120) within QNN-IDM (102) generates notifications based on anomalies from Classify the Anomaly Data (118). This sub-component issues alerts for detected irregularities. Implementation uses a Python script sending email alerts (e.g., smtplib.sendmail(“Anomaly Detected: score=0.95, type=DDoS, source=192.168.1.1”)) or an API call to a dashboard (e.g., requests.post(“https://monitor.com/alerts”, data={“score”: 0.95, “details”: “Packet Flood”})). An example triggers an SMS (“Alert: Unusual traffic from 10.0.0.1”) and logs to a SIEM system (e.g., Splunk) for “score:0.97, ip:10.0.0.1”, while “score:0.3” remains silent, responding to threats like data corruption.

Additional components Data Acquisition (101) through Alert (120) integrate into this flow, with QDP (100) feeding into QNN-IDM (102), each sub-component detailed with clarity, implementation examples, and text incorporation, reflecting the hybrid framework's sophistication.

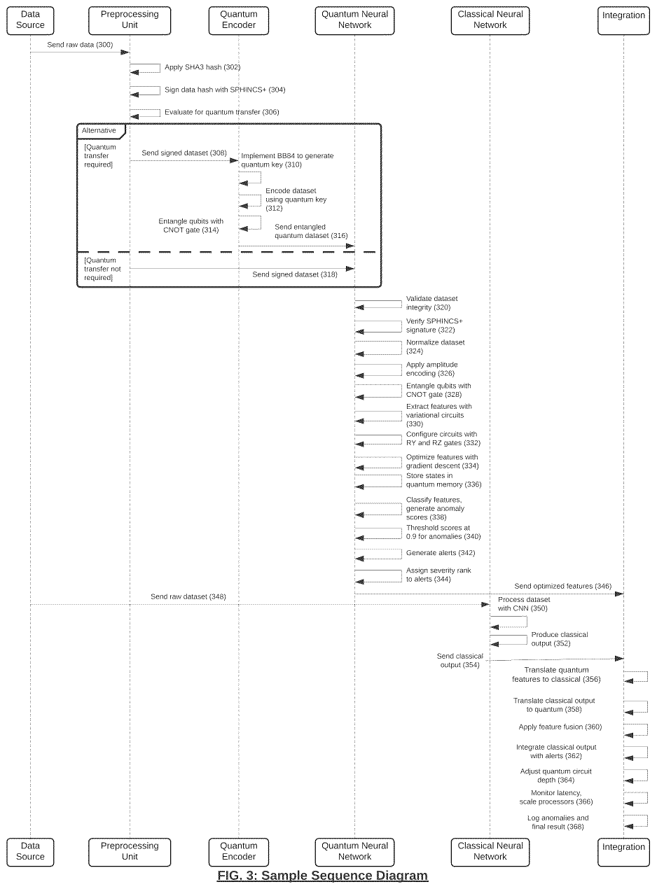

FIG. 2 illustrates a sample system architecture diagram for a hybrid quantum-classical framework designed to detect anomalies in network data, structured with a series of interconnected components that collectively process data from acquisition to alert generation. The diagram begins with the Data Acquisition Module (200), which collects raw data from user inputs and network traffic to form a raw dataset. This module serves as the entry point, gathering information such as login attempts (e.g., “user: admin, pass: 1234”) and network packets (e.g., “source IP: 192.168.1.1, destination IP: 10.0.0.1, payload: 512 bytes”) using tools like Wireshark or API endpoints in a Python Flask application. The raw dataset feeds into the Quantum Data Preprocessing Module (202), which preprocesses the data to generate a quantum-safe signed dataset by applying cryptographic techniques, coordinating subsequent steps like hashing and signing, potentially using a preprocessing script in Python to handle data formatting (e.g., converting JSON data into a binary stream).

The SHA3 Hash Function Component (204) within the preprocessing module applies a quantum-resistant hash function, specifically SHA3, to produce a data hash from the raw dataset, ensuring integrity for classical transmission. For example, it hashes a packet record “timestamp:2025-03-04T10:00, size:1024” into a fixed string like “7f8e9d . . . ” using Python's hashlib.sha3_256() function. This hash passes to the SPHINCS+ Signature Component (206), which signs the data hash with the SPHINCS+ quantum-safe digital signature scheme to ensure strong security and non-repudiation, attaching a signature (e.g., “xyz123abc456. . . ”) verifiable with a public key, implemented via the liboqs library in C. The signed dataset then moves to the Quantum Encoding Module (208), which encodes it into a quantum-encoded dataset using a quantum key distribution protocol when designated for quantum transfer, such as encrypting “data:7f8e9d . . . , sig:xyz123 . . . ” with a key from a QKD system like BB84, manageable in Qiskit.

The BB84 QKD Component (210) generates a quantum key for encryption within the encoding module, producing a key (e.g., “101010 . . . ”) based on the BB84 protocol, executable on a quantum simulator or hardware with photon polarization states (|0>, |1>). The Controlled NOT Gate Entangler (212) entangles qubits of the quantum-encoded dataset using a CNOT gate, linking qubits (e.g., |0> and |1> to |11>) to enhance correlation, implementable in Qiskit with a circuit applying CNOT to a qubit pair. The entangled quantum dataset enters the Quantum Neural Network-Intrusion Detection Model (214), a central module that processes the data through multiple layers to detect anomalies, coordinating sub-components like validation and feature extraction, potentially deployed on a hybrid quantum-classical server.

Within this model, the Validation Layer (216) validates the integrity and authenticity of the quantum-safe signed dataset or entangled quantum dataset, recomputing the hash and verifying the signature (e.g., checking “7f8e9d . . . ” against “xyz123 . . . ” with sphincs_verify( )), using a Python script for hash comparison. The validated dataset proceeds to the Quantum Feature Map Layer (218), which converts it into a quantum state dataset through normalization and encoding, handling data transformation with sub-components, manageable via a Qiskit pipeline. The Normalization Component (220) normalizes the validated dataset to a standard range (e.g., scaling “size:1024” to 0.0156), using NumPy's min-max scaling function. The Amplitude Encoding Component (222) encodes the normalized data into qubit amplitudes (e.g., |ψ>=0.125|000>+0.992|111> for a 3-bit vector), implemented in Qiskit with an encoding circuit. The Controlled NOT Gate Entangler for Quantum States (224) entangles these qubits with a CNOT gate, linking states for correlation (e.g., |00> to |11>), also in Qiskit.

The Feature Extraction Layer (226) extracts quantum features from the entangled quantum state dataset using variational quantum circuits, processing data for anomaly detection with subsequent components, deployable on a quantum processor. The Variational Quantum Circuits Component (228) applies parametrized quantum gates to transform states, using circuits with adjustable parameters (e.g., θ, φ), built in Qiskit. The RY and RZ Rotational Gates Component (230) configures these circuits with RY and RZ gates (e.g., RY(θ=π/4), RZ(φ=π/2)), specifying gate types for pattern detection, also in Qiskit. The Gradient Descent Optimizer Component (232) optimizes the quantum features by minimizing a cost function (e.g., Σ(y_pred−y_true)²), executable with Qiskit's optimization libraries, adjusting gate parameters.

The Variational Quantum Recurrent Network (234) identifies anomalies in the optimized quantum features, storing states and classifying them with sub-components, implemented on a quantum system with recurrent logic. The Quantum Memory Component (236) stores historical states (e.g., past traffic states in a 10-qubit register), maintaining a record for comparison, built in Qiskit with memory circuits. The Anomaly Classification Component (238) classifies the features against historical states to generate anomaly scores (e.g., 0.95 for high variance), using a variational layer in Qiskit. The Threshold Component at 0.9(240 ) thresholds these scores at 0.9 to identify detected anomalies (e.g., score>0.9 flags an anomaly), coded as a simple conditional check in Python.

The Alert Generation Module (242) generates alerts based on detected anomalies, issuing notifications with subsequent severity assignment, integrated via a Python notification script. The Severity Rank Assignment Component (244) assigns a severity rank to each alert based on the anomaly score's magnitude (e.g., 0.95→“High”), using a mapping function in Python (e.g., if score>0.9: rank=“High”). Concurrently, the Classical Neural Network (246) processes the raw dataset from Data Acquisition Module (200) to produce a classical output, handling classical analysis with sub-components, deployable in TensorFlow. The Convolutional Neural Network Component (248) analyzes spatial patterns in the raw dataset (e.g., packet sequence patterns), implemented as a CNN in TensorFlow with convolutional layers.

The Multi-Translation Layer (250) translates the optimized quantum features into a classical format and the classical output into a quantum format, bridging quantum and classical data with sub-components, coded in Python with conversion functions. The Feature Fusion Component (252) applies feature fusion to enhance these translated outputs (e.g., combining quantum variance with classical packet rates), using a fusion algorithm in NumPy. The Integration Module (254) integrates the translated classical output and alerts to produce a final result, combining data streams, implemented as a Python aggregator script. The Persistent Storage System (256) logs the detected anomalies and final result for subsequent analysis (e.g., storing “score:0.95, type: DDoS” in a PostgreSQL database), providing a record-keeping function.

This FIG. 2 diagram encapsulates the core, key, and unique functionalities of the invention, including quantum-safe cryptography with SHA3 and SPHINCS+, quantum encoding with BB84 and CNOT entanglement, quantum neural network processing with variational circuits and recurrent networks, classical convolutional analysis, and hybrid integration with feature fusion, all tied together with persistent storage for comprehensive anomaly detection in network data.

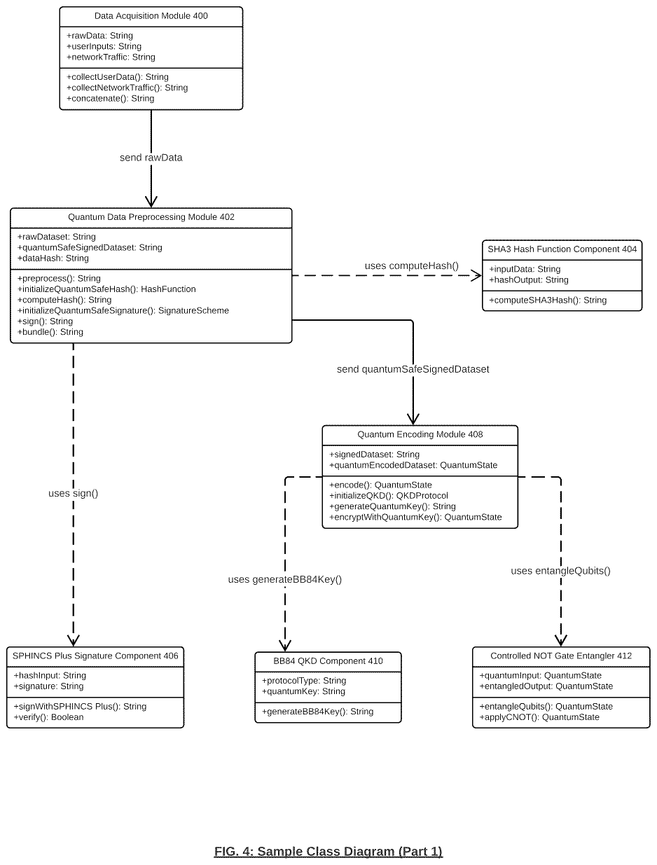

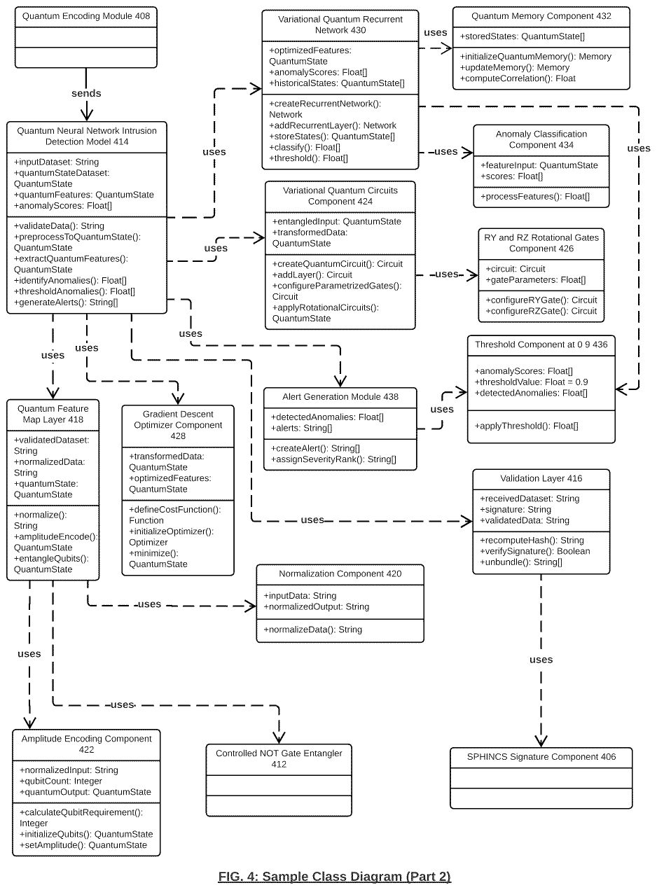

FIG. 3 represents a detailed sequence diagram for a hybrid quantum-classical framework designed to detect anomalies in network data, illustrating the interactions between six distinct actors: Data Source, Preprocessing Unit, Quantum Encoder, Quantum Neural Network, Classical Neural Network, and Integration Unit. The sequence begins with the Data Source sending raw data from user inputs and network traffic to the Preprocessing Unit, where the raw data includes diverse inputs such as login credentials (e.g., “user: admin, pass: 1234”), file uploads (“file: report. pdf, size:2 MB”), and network packets (“source IP: 192.168.1.1, payload: 512 bytes”), forming a comprehensive raw dataset that reflects both structured and unstructured network activity (300). The Preprocessing Unit then applies an SHA3 quantum-resistant hash function to this raw dataset to produce a data hash, transforming the data into a secure, fixed-length string (e.g., hashing “timestamp:2025-03-04T10:00, size:1024” to “7f8e9d . . . ”) to ensure integrity during classical transmission, leveraging the robustness of SHA3's Keccak sponge construction (302).

Following hashing, the Preprocessing Unit signs the data hash with the SPHINCS+ quantum-safe digital signature scheme, attaching a signature (e.g., “xyz123abc456 . . . ”) to the hash to guarantee non-repudiation and strong security, utilizing SPHINCS+'s stateless hash-based approach with Merkle trees to produce a quantum-safe signed dataset verifiable via a public key (304). The Preprocessing Unit evaluates whether the raw dataset is designated for quantum transfer, acting as a decision point that determines the subsequent processing path based on transmission requirements, such as whether the data's sensitivity or network protocol necessitates quantum encoding (306). If quantum transfer is required, the Preprocessing Unit sends the quantum-safe signed dataset to the Quantum Encoder, initiating a quantum-specific processing sequence for enhanced security (308). The Quantum Encoder implements the BB84 quantum key distribution protocol to generate a quantum key for encryption, producing a key (e.g., “101010 . . . ”) through photon polarization states (|0>, |1>) to secure the dataset against quantum threats, reflecting the quantumEncode function's reliance on QKD (310).

The Quantum Encoder then encodes the quantum-safe signed dataset into a quantum-encoded dataset using this quantum key, encrypting the data (e.g., “data:7f8e9d . . . , sig:xyz123 . . . ” into a qubit sequence like |0>|1>|0>) to protect it during transmission, aligning with the quantumEncode process of applying quantum key-based encryption (312). Subsequently, the Quantum Encoder entangles qubits of the quantum-encoded dataset using a controlled NOT gate, linking qubit pairs (e.g., |0> and |1> become |11>) to establish correlations, mirroring the entangleQubits function with CNOT gate application for enhanced data relationship tracking (314). The Quantum Encoder sends this entangled quantum dataset to the Quantum Neural Network, transitioning the data into the anomaly detection phase with quantum-enhanced features intact (316). If quantum transfer is not required, the Preprocessing Unit bypasses the Quantum Encoder and sends the quantum-safe signed dataset directly to the Quantum Neural Network, accommodating classical transmission scenarios where quantum encoding is unnecessary (318).

The Quantum Neural Network validates the integrity and authenticity of the received dataset—either the quantum-safe signed dataset or the entangled quantum dataset—by recomputing the data hash, recalculating the SHA3 hash (e.g., “7f8e9d . . . ” from “size:1024”) to ensure no tampering occurred during transit, consistent with the validateData function's hash recomputation (320). The Quantum Neural Network verifies the SPHINCS+ signature on the recomputed data hash, checking the signature (e.g., “xyz123 . . . ” with the sender's public key) to confirm authenticity and integrity, throwing an exception if verification fails as in the pseudocode's validation logic (322). The Quantum Neural Network normalizes the validated dataset, adjusting values to a standard range (e.g., scaling “size:1024” from 0-65535 to 0.0156) to prepare it for quantum processing, reflecting the preprocessToQuantumState normalization step (324). The Quantum Neural Network applies amplitude encoding to the normalized dataset to convert it into a quantum state dataset, mapping data points to qubit amplitudes (e.g., |ψ>=0.125|000>+0.992|111> for a 3-bit vector), aligning with the amplitudeEncode function's qubit transformation (326).

The Quantum Neural Network entangles qubits of the quantum state dataset using a controlled NOT gate, linking states (e.g., |00> to |11>) to enhance feature correlations, mirroring the entangleQubits application within preprocessToQuantumState (328). The Quantum Neural Network extracts quantum features from the entangled quantum state dataset using variational quantum circuits with parametrized rotational gates, transforming states to detect patterns (e.g., applying RY(θ=π/4)), consistent with the extractQuantumFeatures function's variational circuit use (330). The Quantum Neural Network configures these variational quantum circuits with RY and RZ rotational gates, specifying gate types (e.g., RY(θ), RZ(φ)) to optimize pattern recognition, reflecting the configureParametrizedGates step (332). The Quantum Neural Network optimizes the quantum features using a gradient descent optimizer, minimizing a cost function (e.g., Σ(y_pred-y_true)²) to refine features, as in the optimizeFeatures function with gradient descent (334).

The Quantum Neural Network stores historical states of the optimized quantum features in a quantum memory, maintaining a record (e.g., past states in a 10-qubit register) for temporal analysis, matching the storeStates function's quantum memory update (336). The Quantum Neural Network classifies the optimized quantum features against historical states to generate anomaly scores, producing scores (e.g., 0.95 for high variance) via a variational layer, consistent with the classify function in the VQRN (338). The Quantum Neural Network thresholds the anomaly scores at 0.9 to identify detected anomalies, flagging scores above 0.9 (e.g., 0.95→anomaly), aligning with the thresholdAnomalies function's cutoff (340). The Quantum Neural Network generates alerts based on the detected anomalies, creating notifications (e.g., “Anomaly: score=0.95”), reflecting the generateAlerts function's output (342).

The Quantum Neural Network assigns a severity rank to each alert based on the anomaly score magnitude, mapping scores to ranks (e.g., 0.95→“High”), using a conditional logic as in the pseudocode's alert generation (344). The Quantum Neural Network sends the optimized quantum features to the Integration Unit, providing quantum-derived data for final processing, consistent with the multiTranslationLayer's input (346). Concurrently, the Data Source sends the raw dataset to the Classical Neural Network, initiating a parallel classical processing path with the same data (e.g., “size:1024, ip:192.168.1.1”) as sent to the Preprocessing Unit (348). The Classical Neural Network processes the raw dataset using a convolutional neural network to analyze spatial patterns, extracting features like packet sequence patterns, leveraging the processClassicalNetwork function's forward pass (350).

The Classical Neural Network produces a classical output from the processed raw dataset, generating results (e.g., “pattern:regular, rate:100 pkt/s”) from convolutional analysis, as in the classical neural network's output (352). The Classical Neural Network sends this classical output to the Integration Unit, providing classical data for integration with quantum results, mirroring the multiTranslationLayer's classical input (354). The Integration Unit translates the optimized quantum features into a classical format, converting quantum states (e.g., qubit amplitudes to numerical values) for compatibility, reflecting the convertQuantumToClassical function (356). The Integration Unit translates the classical output into a quantum format, transforming classical data (e.g., “rate:100 pkt/s” to qubit states) for hybrid processing, as in the convertClassicalToQuantum function (358).

The Integration Unit applies feature fusion to enhance the translated classical output and translated quantum input, combining features (e.g., quantum variance with classical rates) into a unified representation, extending the multiTranslationLayer's enhancement capability (360). The Integration Unit integrates the translated classical output with the alerts to produce a final result, merging data streams (e.g., “score:0.95, type: DDoS” with “pattern:irregular”) into a comprehensive output, consistent with the integrateResults function (362). The Integration Unit adjusts the depth of variational quantum circuits based on raw dataset complexity, modifying circuit layers (e.g., adding RY gates for complex traffic) to optimize processing, reflecting adaptive configuration from system components (364). The Integration Unit monitors the latency of the Quantum Neural Network and scales quantum processors for real-time processing, adjusting resources (e.g., adding qubits if latency>1 ms) to maintain efficiency, incorporating system monitoring functionality (366).

The Integration Unit logs the detected anomalies and final result into a persistent storage system, storing data (e.g., “score:0.95, type: DDoS, time: 2025-03-04T10:00” in a PostgreSQL database) for analysis, aligning with persistent storage system capabilities and the integrateResults logging step (368). This sequence diagram in FIG. 3 encapsulates the invention's core elements—quantum-safe cryptography with SHA3 and SPHINCS+, quantum encoding via BB84 and CNOT entanglement, quantum neural network analysis with variational circuits and memory, classical convolutional processing, and hybrid integration with feature fusion—while detailing process limitations like specific hash functions, signature schemes, encoding protocols, gate types, threshold values, and severity ranking, ensuring a precise, comprehensive flow from data initiation to actionable outcomes.

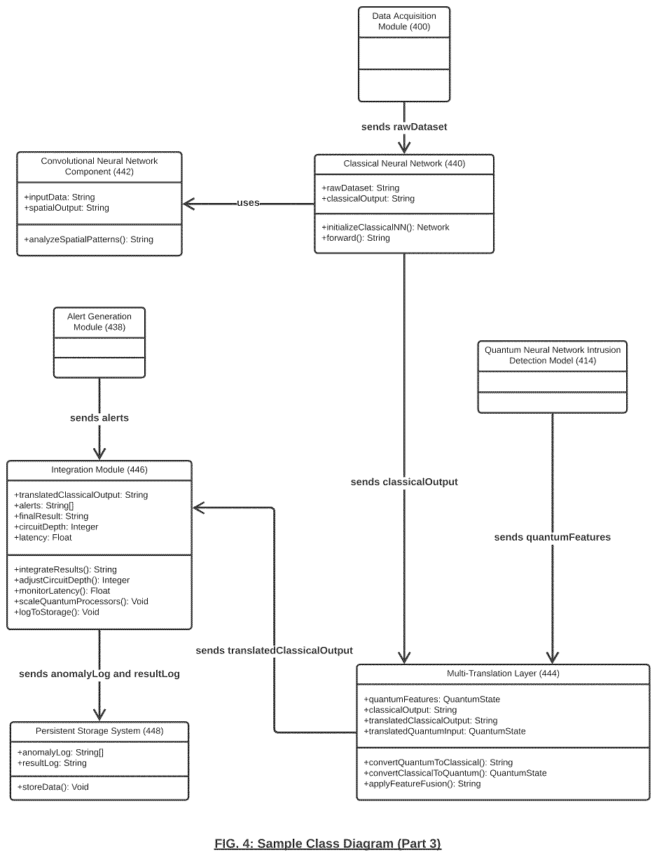

FIG. 4 represents a comprehensive class diagram for a hybrid quantum-classical framework designed to detect anomalies in network data, segmented into three distinct parts—Part 1, Part 2, and Part 3—each detailing a subset of classes that collectively encapsulate the invention's key functionalities, processes, steps, components, and elements derived from system and method descriptions as well as pseudocode. Part 1 focuses on data acquisition and preprocessing, beginning with the Data Acquisition Module (400), which includes attributes such as rawData, userInputs, and networkTraffic, all defined as strings to store collected data, and methods like collectUserData(), collectNetworkTraffic(), and concatenate() to gather and combine user inputs (e.g., “login:user1”) and network traffic (e.g., “packet: 192.168.1.1”) into a unified raw dataset. This class connects to the Quantum Data Preprocessing Module (402), which manages attributes like rawDataset, quantumSafeSignedDataset, and dataHash, all strings, and offers methods including preprocess(), initializeQuantumSafeHash(), computeHash(), initializeQuantumSafeSignature(), sign(), and bundle() to transform the raw dataset into a secure, signed form (e.g., “data:7f8e9d . . . , sig:xyz123 . . . ”), utilizing cryptographic tools.

The Quantum Data Preprocessing Module (402) interacts with the SHA3 Hash Function Component (404), which has attributes inputData and hashOutput as strings and a method computeSHA3Hash() to generate a hash (e.g., “7f8e9d . . . ” from “size:1024”) using the SHA3 algorithm, ensuring quantum resistance. It also connects to the SPHINCS+ Signature Component (406), featuring attributes hashInput and signature as strings and methods signWithSPHINCS+() and verify() to sign the hash with a SPHINCS+ signature (e.g., “xyz123 . . . ”) and validate it, providing robust security. The preprocessing flow continues to the Quantum Encoding Module (408), with attributes signedDataset as a string and quantumEncodedDataset as a QuantumState type, and methods encode(), initializeQKD(), generateQuantumKey(), and encryptWithQuantumKey() to encode the signed dataset into a quantum state (e.g., |0>|1>|0>) using a quantum key. This module uses the BB84 QKD Component (410), which includes attributes protocolType and quantumKey as strings and a method generateBB84Key() to produce a key (e.g., “101010 . . . ”) via the BB84 protocol, and the Controlled NOT Gate Entangler (412), with attributes quantumInput and entangledOutput as QuantumState types and methods entangleQubits() and applyCNOT() to entangle qubits (e.g., |00> to |11>), completing the preprocessing phase in Part 1.

Part 2 shifts focus to quantum neural network processing, starting with the Quantum Neural Network Intrusion Detection Model (414), a central class with attributes inputDataset as a string, quantumStateDataset and quantumFeatures as QuantumState types, and anomalyScores as an array of floats, alongside methods validateData(), preprocessToQuantumState(), extractQuantumFeatures(), identifyAnomalies(), thresholdAnomalies(), and generateAlerts() to process data through validation, feature extraction, and anomaly detection, producing outputs like anomaly scores (e.g., [0.95, 0.2]) and alerts (e.g., “Anomaly: DDoS”). This class connects to the Validation Layer (416), which has attributes receivedDataset, signature, and validatedData as strings and methods recomputeHash(), verifySignature(), and unbundle() to validate data integrity and authenticity (e.g., recomputing “7f8e9d . . . ” and verifying “xyz123 . . . ”), leveraging the SPHINCS+ Signature Component (406) from Part 1 for verification. The Quantum Feature Map Layer (418) follows, with attributes validatedDataset and normalizedData as strings and quantumState as a QuantumState type, and methods normalize(), amplitudeEncode(), and entangleQubits() to convert data into a quantum state, utilizing the Normalization Component (420) with attributes inputData and normalizedOutput as strings and a method normalizeData() to scale values (e.g., “size:1024” to 0.0156), and the Amplitude Encoding Component (422) with attributes normalizedInput as a string, qubitCount as an integer, and quantumOutput as a QuantumState type, and methods calculateQubitRequirement(), initializeQubits(), and setAmplitude() to encode data into qubits (e.g., |ψ>=0.125|000>+0.992|111>).

The Quantum Feature Map Layer (418) also uses the Controlled NOT Gate Entangler (412) from Part 1 to entangle qubits, feeding into the Variational Quantum Circuits Component (424), which has attributes entangledInput and transformedData as QuantumState types and methods createQuantumCircuit(), addLayer(), configureParametrizedGates(), and applyRotationalCircuits() to transform quantum states for feature extraction, employing the RY and RZ Rotational Gates Component (426) with attributes circuit as a Circuit type and gateParameters as an array of floats and methods configureRYGate() and configureRZGate() to specify RY and RZ gates (e.g., RY(θ=π/4)). The Gradient Descent Optimizer Component (428) optimizes these features, with attributes transformedData and optimizedFeatures as QuantumState types and methods defineCostFunction(), initializeOptimizer(), and minimize() to refine features via gradient descent (e.g., minimizing Σ(y_pred−y_true)²). The Variational Quantum Recurrent Network (430) identifies anomalies, with attributes optimizedFeatures as a QuantumState type, anomalyScores as an array of floats, and historicalStates as an array of QuantumState types, and methods createRecurrentNetwork(), addRecurrentLayer(), storeStates(), classify(), and threshold() to classify and threshold anomalies (e.g., scores>0.9), using the Quantum Memory Component (432) with an attribute storedStates as an array of QuantumState types and methods initializeQuantumMemory(), updateMemory(), and computeCorrelation() to store states (e.g., past traffic patterns), and the Anomaly Classification Component (434) with attributes featureInput as a QuantumState type and scores as an array of floats and a method processFeatures() to generate scores. The Threshold Component at 0.9 (436) with attributes anomalyScores and detectedAnomalies as arrays of floats and thresholdValue as a float set to 0.9 and a method applyThreshold() filters anomalies, feeding into the Alert Generation Module (438), which has attributes detectedAnomalies as an array of floats and alerts as an array of strings and methods createAlert() and assignSeverityRank() to produce ranked alerts (e.g., “High: score=0.95”).

Part 3 addresses classical processing and integration, starting with the Classical Neural Network (440), which includes attributes rawDataset and classicalOutput as strings and methods initializeClassicalNN() and forward() to process the raw dataset from Data Acquisition Module (400) into a classical output (e.g., “pattern:regular”), utilizing the Convolutional Neural Network Component (442) with attributes inputData and spatialOutput as strings and a method analyzeSpatialPatterns() to analyze spatial patterns (e.g., packet sequences). The Multi-Translation Layer (444) bridges quantum and classical data, with attributes quantumFeatures as a QuantumState type, classicalOutput, translatedClassicalOutput as strings, and translatedQuantumInput as a QuantumState type, and methods convertQuantumToClassical(), convertClassicalToQuantum(), and applyFeatureFusion() to translate and fuse data (e.g., combining “variance:0.8” with “rate:100 pkt/s”), receiving quantumFeatures from Quantum Neural Network Intrusion Detection Model (414) and classicalOutput from Classical Neural Network (440). The Integration Module (446) consolidates the process, with attributes translatedClassicalOutput and finalResult as strings, alerts as an array of strings, circuitDepth as an integer, and latency as a float, and methods integrateResults(), adjustCircuitDepth(), monitorLatency(), scaleQuantumProcessors(), and logToStorage() to integrate outputs (e.g., “score:0.95, pattern:irregular”), adjust circuit depth based on complexity (e.g., adding layers for high traffic), monitor latency (e.g., ensuring <1 ms), and scale resources, receiving translatedClassicalOutput from Multi-Translation Layer (444) and alerts from Alert Generation Module (438). The Persistent Storage System (448) concludes the flow, with attributes anomalyLog as an array of strings and resultLog as a string and a method storeData() to log results (e.g., “score:0.95, type: DDoS” in a database), connected to Integration Module (446).

This three-part class diagram in FIG. 4 encapsulates the invention's core architecture, detailing data acquisition, quantum-safe preprocessing with SHA3 and SPHINCS+, quantum encoding with BB84 and CNOT gates, quantum neural network processing with variational circuits and recurrent networks, classical convolutional analysis, and hybrid integration with feature fusion, logging, and dynamic adjustments, providing a precise object-oriented representation of the anomaly detection system.

Pseudocode exemplars for implementing various aspects of this disclosure are set forth below with explanations for reference.
// Data Acquisition Function
function acquireData(userInput, networkTraffic)
   data=collectUserData(userInput)
   trafficData=collectNetworkTraffic(networkTraffic)
   rawData=concatenate(data, trafficData)
   return rawData
// Quantum Data Preprocessing (QDP) Function
function quantumDataPreprocessing(rawData)
   hashFunction=initializeQuantumSafeHash(“SHA3”)
   dataHash=hashFunction.computeHash(rawData)
      signatureScheme=initializeQuantumSafeSignature(“SPHINCS+”)
   quantumSafeSignature=signatureScheme.sign(dataHash)
   signedData=bundle(rawData, quantumSafeSignature)
   if isQuantumTransfer(rawData)
      quantumEncodedData=quantumEncode(signedData, “QKD”)
      return quantumEncodedData
   else
      return signedData
// Quantum Encoding Function
function quantumEncode(data, protocol)
   qkdProtocol=initializeQKD(protocol)
   quantumKey=qkdProtocol.generateKey()
   encodedData=encryptWithQuantumKey(data, quantumKey)
   entangledData=entangleQubits(encodedData, “CNOT”)
   return entangledData
// Quantum Neural Network-Intrusion Detection Model (QNN-IDM)
Main Function
function qnnIntrusionDetection(signedData)
   validatedData=validateData(signedData)
   quantumStateData=preprocessToQuantumState(validatedData)
   features=extractQuantumFeatures(quantumStateData)
   anomalies=identifyAnomalies(features)
   alerts=generateAlerts(anomalies)
   return alerts
// Data Validation Function
function validateData(signedData)
   signatureScheme=initializeQuantumSafeSignature(“SPHINCS+”)
   receivedData, receivedSignature=unbundle(signedData)
   recomputedHash=hashFunction.computeHash(receivedData)
      isValid=signatureScheme.verify(recomputedHash,
receivedSignature)
   if isValid
      return receivedData
   else
      throw “Data Integrity Validation Failed”
// Quantum Feature Map Layer Function
function preprocessToQuantumState(validatedData)
   normalizedData=normalize(validatedData)
   quantumState=amplitudeEncode(normalizedData)
   entangledState=entangleQubits(quantumState, “CNOT”)
   return entangledState
// Amplitude Encoding Function
function amplitudeEncode(data)
   qubitCount=calculateQubitRequirement(data.size)
   qubits=initializeQubits(qubitCount)
   for i=0 to data.size−1
      amplitude=normalizeAmplitude(data[i])
      qubits[i].setAmplitude(amplitude)
   return qubits
// Entangle Qubits Function
function entangleQubits(quantumState, gateType)
   entangledState=quantumState
   for i=0 to quantumState.size−2
      if gateType==“CNOT”
         entangledState=applyCNOT(entangledState[i], entangledState[i+1])
      return entangledState
// Quantum Feature Extraction Function
function extractQuantumFeatures(quantumStateData)
   variationalCircuit=initializeVariationalCircuit()
      parametrizedGates=configureParametrizedGates(variationalCircuit)
   transformedData=applyRotationalCircuits(quantumStateData, parametrizedGates)
   optimizedFeatures=optimizeFeatures(transformedData)
   return optimizedFeatures
// Variational Circuit Initialization
function initializeVariationalCircuit()
   circuit=createQuantumCircuit()
   circuit.addLayer(“RY”)
   circuit.addLayer(“RZ”)
   circuit.addEntanglementLayer(“CNOT”)
   return circuit
// Configure Parametrized Gates
function configureParametrizedGates(circuit)
   parameters=generateRandomParameters(circuit.layerCount)
   for layer in circuit.layers
      layer.setParameters(parameters[layer.index])
   return circuit
// Apply Rotational Circuits
function applyRotationalCircuits(quantumState, gates)
   transformedState=quantumState
   for gate in gates
      transformedState=gate.apply(transformedState)
   return transformedState
// Optimize Features Function
function optimizeFeatures(transformedData)
   costFunction=defineCostFunction()
   optimizer=initializeOptimizer(“GradientDescent”)
      optimizedData=optimizer.minimize(costFunction, transformedData)
   return optimizedData
// Anomaly Identification Function
function identifyAnomalies(features)
   vqrn=initializeVariationalQuantumRecurrentNetwork()
   quantumMemory=vqrn.storeStates(features)
   anomalyScores=vqrn.classify(features, quantumMemory)
   anomalies=thresholdAnomalies(anomalyScores, 0.9)
   return anomalies
// Variational Quantum Recurrent Network Initialization
function initializeVariationalQuantumRecurrentNetwork()
   vqrn=createQuantumRecurrentNetwork()
   vqrn.addRecurrentLayer(“QuantumMemory”)
   vqrn.addClassificationLayer()
   return vqrn
// Store States in Quantum Memory
function storeStates(features)
   memory=initializeQuantumMemory()
   for feature in features
      memory.update(feature)
   return memory
// Classify with VQRN
function classify(features, quantumMemory)
   scores=[]
   for feature in features
      correlation=quantumMemory.computeCorrelation(feature)
      score=variationalLayer.process(feature, correlation)
      scores.append(score)
   return scores
// Threshold Anomalies
function thresholdAnomalies(scores, threshold)
   anomalies=[]
   for score in scores
      if score>threshold
         anomalies.append(score)
   return anomalies
// Generate Alerts Function
function generateAlerts(anomalies)
   alerts=[]
   for anomaly in anomalies
      alert=createAlert(anomaly)
      alerts.append(alert)
   return alerts
// Multi-Translation Layer Function
function multiTranslationLayer(quantumOutput, classicalInput)
   translatedQuantum=convertQuantumToClassical(quantumOutput)
   translatedClassical=convertClassicalToQuantum(classicalInput)
   hybridOutput=combine(translatedQuantum, classicalInput)
   hybridInput=combine(quantumOutput, translatedClassical)
   return hybridOutput, hybridInput
// Convert Quantum to Classical
function convertQuantumToClassical(quantumData)
   classicalData=measureQubits(quantumData)
   return classicalData
// Convert Classical to Quantum
function convertClassicalToQuantum(classicalData)
   quantumData=amplitudeEncode(classicalData)
   return quantumData
// Main Execution Flow
function main(userInput, networkTraffic)
   rawData=acquireData(userInput, networkTraffic)
   processedData=quantumDataPreprocessing(rawData)
   alerts=qnnIntrusionDetection(processedData)
   quantumOutput=extractQuantumOutput(processedData)
   classicalOutput=processClassicalNetwork(rawData)
      hybridOutput, hybridInput=multiTranslationLayer(quantumOutput, classicalOutput)
   finalResult=integrateResults(hybridOutput, alerts)
   return finalResult
// Process Classical Network
function processClassicalNetwork(rawData)
   classicalNN=initializeClassicalNeuralNetwork()
   classicalOutput=classicalNN.forward(rawData)
   return classicalOutput
// Integrate Results
function integrateResults(hybridOutput, alerts)
   result=combine(hybridOutput, alerts)
   return result

The pseudocode begins with a data acquisition function that collects raw data from user inputs and network traffic, combining them into a single dataset for processing. This function, named acquireData, takes two parameters—userInput and networkTraffic—and uses internal procedures to gather user-specific data and traffic-related data, respectively, before merging them into a unified rawData variable that is returned for further handling. This initial step ensures that all relevant information from both sources is captured systematically to serve as the foundation for subsequent analysis within the framework.

Following data collection, the quantumDataPreprocessing function processes the raw data to secure it using quantum-safe cryptographic techniques. It starts by initializing a quantum-resistant hash function, specified as SHA3, to compute a hash of the raw data, creating a unique digest called dataHash. A quantum-safe signature scheme, SPHINCS+, is then initialized to sign this hash, producing a quantumSafeSignature that is bundled with the raw data into signedData. The function checks if the data requires quantum transfer; if so, it invokes a quantumEncode function with a quantum key distribution protocol (QKD) to encode the signed data, returning the quantum-encoded result, otherwise it returns the signedData directly, ensuring flexibility for classical or quantum transmission scenarios.

The quantumEncode function handles the encoding of data for quantum transfer by initializing a QKD protocol to generate a quantumKey, which is used to encrypt the input data into an encodedData form. This encrypted data is then subjected to entanglement using a controlled NOT (CNOT) gate, applied across qubits to produce entangledData, which enhances the data's security and correlation properties before returning it. This process ensures that data destined for quantum channels is protected and prepared for quantum processing, leveraging entanglement as a unique feature of the system.

The core of the anomaly detection framework is encapsulated in the qnnIntrusionDetection function, which orchestrates the entire detection process on the signedData input. It first calls validateData to confirm the data's authenticity and integrity, then preprocesses the validated data into a quantum state using preprocessToQuantumState. The resulting quantum state undergoes feature extraction via extractQuantumFeatures, followed by anomaly identification with identifyAnomalies, and concludes with generating alerts through generateAlerts, returning these alerts as the output, providing a streamlined flow from validation to notification.

Data validation is detailed in the validateData function, which unbundles the signedData into receivedData and receivedSignature components. It reinitializes the SPHINCS+ signature scheme and recomputes the hash of the received data using the same hash function from preprocessing. The function then verifies the recomputed hash against the received signature; if valid, it returns the received data for further processing, but if verification fails, it throws an exception to halt the process, ensuring only authentic data proceeds.

The preprocessToQuantumState function transforms validated classical data into a quantum state suitable for analysis. It normalizes the input data to standardize its range, then applies amplitudeEncode to convert it into a quantum state represented by qubits. These qubits are entangled using the entangleQubits function with CNOT gates to establish correlations, returning the entangledState, which prepares the data for quantum feature extraction by enhancing its relational structure.

Within amplitudeEncode, the function calculates the number of qubits needed based on the data size and initializes them accordingly. It iterates over the data, normalizing each value's amplitude and setting it to the corresponding qubit, effectively encoding the classical data into a quantum format that preserves its magnitude information, returning the resulting qubit array for entanglement and further processing.

The entangleQubits function takes a quantum state and applies entanglement using the specified gate type, here CNOT, across consecutive qubits in the state. It iterates through the quantum state, applying the CNOT operation between each pair, modifying the state in-place until all applicable pairs are entangled, then returns the entangled state, which strengthens data correlations critical for anomaly detection.

Feature extraction occurs in the extractQuantumFeatures function, which initializes a variational quantum circuit to process the quantum state data. It configures parametrized gates within the circuit, applies rotational circuits to transform the data, and optimizes the resulting features using a minimization process, returning optimizedFeatures that represent the data in a form suitable for anomaly identification, leveraging quantum circuit flexibility.

The initializeVariationalCircuit function creates a quantum circuit with layers of rotational gates (RY and RZ) and an entanglement layer using CNOT gates, structuring a circuit capable of learning data transformations, which is returned for configuration and application, forming the backbone of quantum feature manipulation.

In configureParametrizedGates, the function generates random parameters for each layer of the variational circuit and assigns them accordingly, enabling the circuit to adaptively transform quantum states based on these parameters, returning the configured circuit for use in feature extraction, ensuring dynamic learning capability.

The applyRotationalCircuits function processes the quantum state by sequentially applying each parametrized gate from the configured circuit, transforming the state step-by-step into a new representation that highlights relevant features, returning this transformed state for optimization, reflecting the quantum circuit's role in data manipulation.

Optimization in optimizeFeatures defines a cost function to evaluate the transformed data's quality and initializes a gradient descent optimizer to minimize this cost, refining the data into optimized features that enhance detection accuracy, which are then returned for anomaly classification, completing the feature extraction pipeline.

Anomaly identification is handled by identifyAnomalies, which initializes a Variational Quantum Recurrent Network (VQRN) to process the extracted features. It stores the features in quantum memory, classifies them based on stored states to compute anomaly scores, and applies a threshold to identify significant anomalies, returning these as the output, leveraging quantum memory for temporal analysis.

The initializeVariationalQuantumRecurrentNetwork function creates a VQRN with a quantum memory layer and a classification layer, structuring a network that can retain and analyze state history, returning it for use in anomaly detection, embodying the system's recurrent quantum processing capability.

The storeStates function initializes quantum memory and updates it with each feature, maintaining a historical record of data states that enables tracking changes over time, returning the populated memory for classification, supporting the VQRN's temporal awareness.

Classification in the classify function computes anomaly scores by iterating over features, calculating correlations with quantum memory, and processing each feature through a variational layer to assign a score, returning an array of scores that indicate potential anomalies, integrating memory and learning for precise detection.

The thresholdAnomalies function filters the anomaly scores against a specified threshold (0.9), collecting scores exceeding this value into an array of anomalies, which is returned to represent detected irregularities, finalizing the identification process with a clear cutoff.

Alerts are generated by the generateAlerts function, which iterates over identified anomalies and creates an alert for each, returning an array of alerts that can be used to notify relevant systems or personnel, ensuring actionable output from the detection process.

The multiTranslationLayer function bridges quantum and classical processing by converting quantum output to classical form and classical input to quantum form using dedicated conversion functions, then combining these into hybrid outputs and inputs, returning both to enable seamless interaction between the two paradigms, reflecting the hybrid nature of the framework.

Conversion from quantum to classical in convertQuantumToClassical measures the qubits of the quantum data to produce classical data, returning this result for use in classical processing, providing a straightforward transition method.

Conversely, convertClassicalToQuantum uses amplitude encoding to transform classical data into a quantum state, returning the quantum data for quantum processing, ensuring compatibility across the hybrid system.

The main function orchestrates the entire workflow, starting with data acquisition, followed by quantum preprocessing and intrusion detection, then processes quantum and classical outputs separately before integrating them via the multi-translation layer, returning a final result that combines hybrid outputs and alerts, serving as the entry point for the system.

Classical processing in processClassicalNetwork initializes a classical neural network and performs a forward pass on the raw data, returning the output for integration with quantum results, maintaining compatibility with traditional systems.

Finally, integrateResults combines the hybrid output with alerts into a cohesive result, returning it as the culmination of the detection process, ensuring all components are unified in the final output, completing the pseudocode's implementation of the invention's features.

A skilled artisan, upon reviewing the disclosure, will appreciate that there are numerous alternatives, modifications, combinations, and customizations that can be made to the systems and methods described herein.

The systems and methods described in this disclosure offer a robust framework for anomaly detection that can be adapted through various alternatives, modifications, combinations, and customizations while remaining consistent with its foundational principles. One potential alternative involves substituting the specified quantum-safe hash function, SHA3, with other quantum-resistant algorithms such as BLAKE3 or a different variant from the BLAKE family, allowing for flexibility in cryptographic strength or computational efficiency depending on specific implementation needs. Similarly, the SPHINCS+ signature scheme could be replaced with other hash-based signature methods like XMSS or LMS, which might offer trade-offs in terms of signature size, verification speed, or resistance to specific quantum threats, tailoring the system to varying security requirements.

Another modification could involve altering the quantum encoding technique used during data preprocessing. While the disclosure employs amplitude encoding for large datasets, an alternative approach could utilize angle encoding or basis encoding for different data types, such as time-series or sparse datasets, potentially improving the quantum state preparation process for specialized applications. Additionally, the entanglement method using CNOT gates could be customized to incorporate other quantum gates, such as CZ (controlled-Z) or SWAP gates, to explore different entanglement patterns that might enhance correlation detection in unique network traffic scenarios.

The variational quantum circuits central to feature extraction present opportunities for customization by adjusting the structure of the circuit layers. Instead of the described RY and RZ rotational gates, the system could integrate RX gates or multi-qubit gates like Toffoli gates to diversify the transformations applied to quantum states, potentially increasing the expressiveness of the learned features. The number of layers in these circuits could also be varied—adding more layers for deeper analysis or reducing them for faster processing—allowing the system to balance complexity and performance based on operational constraints.

The optimization process within feature extraction could be modified by replacing the gradient descent optimizer with alternatives such as Adam, RMSprop, or even quantum-specific optimizers like the parameter-shift rule, which might offer faster convergence or better handling of noisy quantum data. Furthermore, the cost function used in this optimization could be tailored to emphasize different detection priorities, such as minimizing false positives versus maximizing anomaly sensitivity, enabling the system to adapt to specific organizational goals.

The Variational Quantum Recurrent Network (VQRN) used for anomaly identification could be customized by altering its architecture. For instance, additional recurrent layers could be added to increase the depth of temporal analysis, or the quantum memory could be expanded to store a larger history of states, enhancing the system's ability to detect long-term patterns. Alternatively, the classification layer could incorporate classical recurrent neural network elements, such as LSTM units, in a hybrid configuration to combine quantum and classical temporal processing strengths.

The threshold value for anomaly detection, set at 0.9 in the pseudocode, represents a customizable parameter that could be adjusted dynamically based on real-time network conditions or historical data analysis, allowing for a more adaptive response to fluctuating threat levels. This threshold could also be replaced with a machine learning model that predicts optimal cutoff points, integrating predictive analytics into the framework for greater precision.

The hybrid architecture, bridging quantum and classical neural networks, could be modified by adjusting the multi-translation layer's functionality. For example, instead of a simple conversion between quantum and classical states, this layer could incorporate additional processing steps, such as dimensionality reduction or feature fusion, to enrich the data exchanged between the two systems. The classical neural network component could also be swapped with alternative models, like convolutional neural networks for spatial data or transformers for sequential data, expanding the system's applicability to diverse datasets.

Data acquisition methods could be customized to include additional sources beyond user input and network traffic, such as system logs, IoT device outputs, or external threat intelligence feeds, broadening the scope of information analyzed. The preprocessing pipeline could be extended to include classical data cleaning steps—like outlier removal or missing value imputation—before quantum encoding, ensuring higher-quality input into the quantum layers.

The alert generation process offers room for modification by integrating multi-channel notification systems, such as email, SMS, or API calls, to suit different operational environments. Alerts could also be prioritized based on anomaly severity scores, adding a ranking mechanism that enhances response efficiency. Additionally, the system could log anomalies into a persistent storage system for post-event analysis, creating a feedback loop to refine detection over time.

Combinations of these elements could be explored, such as pairing an alternative hash function like BLAKE3 with a modified variational circuit using RX gates, to optimize both security and feature extraction for a specific use case. Another combination might involve using angle encoding with an expanded VQRN architecture to target time-series anomalies in financial transaction networks, leveraging the system's adaptability to specialized domains.

The quantum key distribution (QKD) protocol used in quantum transfer could be customized by selecting specific implementations, such as BB84 or E91, depending on the desired balance between security and implementation complexity. This could be combined with a modified entanglement strategy, like using CZ gates, to create a unique quantum preprocessing pipeline tailored to high-security applications.

The system's real-time capabilities could be enhanced by parallelizing certain functions, such as running feature extraction and anomaly identification concurrently on separate quantum processors, reducing overall latency. This modification could be paired with a dynamic threshold adjustment to maintain responsiveness in high-traffic scenarios, ensuring scalability.

Customization could extend to deployment configurations, allowing the Quantum Neural Network-Intrusion Detection Model to operate as a distributed system across multiple nodes rather than a centralized gateway. This could involve replicating the preprocessing and detection layers across edge devices, with results aggregated at a central hub, improving fault tolerance and coverage in large-scale networks.

The pseudocode's main execution flow could be altered to include iterative processing loops, where data is reprocessed multiple times with updated parameters to refine anomaly detection iteratively. This could be combined with a feedback mechanism from the alerts to adjust preprocessing or feature extraction, creating a self-improving system over time.

For environments with limited quantum resources, the framework could be modified to offload more processing to the classical neural network, reducing reliance on quantum hardware while retaining hybrid benefits. This could involve expanding the classical network's role in feature extraction or anomaly scoring, with the quantum component focused solely on encoding and entanglement.

The integration of external libraries, such as liboqs for signature schemes, could be replaced with custom implementations or other open-source alternatives, allowing for greater control over cryptographic performance or compliance with specific standards. This customization could be combined with a modular design, where individual components like hashing or encoding are interchangeable plug-ins, enhancing maintainability.

Another modification might involve adding a visualization layer to the system, where quantum states or anomaly scores are rendered graphically for human oversight, complementing the automated alerts with manual review capabilities. This could be paired with a customization of the alert format to include detailed diagnostic data, aiding in forensic analysis.

The system could also incorporate machine learning models to predict optimal configurations for variational circuits or encoding methods based on historical data, automating the customization process. This could be combined with a simulation mode, where the framework tests alternative configurations in a virtual environment before deployment, ensuring robustness.

For specific industries, the framework could be tailored by adjusting data types and detection focus—for example, prioritizing packet-level analysis in telecommunications or transaction integrity in banking—while retaining the core hybrid and quantum-safe structure. This customization could involve combining industry-specific preprocessing with modified anomaly thresholds, aligning the system with domain-specific needs.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment.

1. A method for detecting anomalies in network data using a hybrid quantum-classical framework, the method comprising:
acquiring, by a data acquisition module, raw data from user inputs and network traffic to form a raw dataset;
preprocessing, by a quantum data preprocessing module, the raw dataset to generate a quantum-safe signed dataset by applying a quantum-resistant hash function to produce a data hash and signing the data hash with a quantum-safe digital signature scheme;
encoding, by a quantum encoding module, the quantum-safe signed dataset into a quantum-encoded dataset using a quantum key distribution protocol when the raw dataset is designated for quantum transfer;
entangling, by the quantum encoding module, qubits of the quantum-encoded dataset using a controlled NOT gate to produce an entangled quantum dataset;
validating, by a validation layer of a quantum neural network-intrusion detection model, integrity and authenticity of the quantum-safe signed dataset or the entangled quantum dataset to produce a validated dataset;
converting, by a quantum feature map layer of the quantum neural network-intrusion detection model, the validated dataset into a quantum state dataset by normalizing the validated dataset and applying amplitude encoding;
entangling, by the quantum feature map layer, qubits of the quantum state dataset using a controlled NOT gate to produce an entangled quantum state dataset;
extracting, by a feature extraction layer of the quantum neural network-intrusion detection model, quantum features from the entangled quantum state dataset using variational quantum circuits with parametrized rotational gates;
optimizing, by the feature extraction layer, the quantum features using a gradient descent optimizer to produce optimized quantum features;
identifying, by a variational quantum recurrent network of the quantum neural network-intrusion detection model, anomalies in the optimized quantum features by storing historical states in a quantum memory and classifying the optimized quantum features against the historical states to generate anomaly scores;
thresholding, by the variational quantum recurrent network, the anomaly scores against a predefined threshold to identify detected anomalies;
generating, by an alert generation module, alerts based on the detected anomalies;
processing, by a classical neural network, the raw dataset to produce a classical output;
translating, by a multi-translation layer, the optimized quantum features into a classical format to produce a translated classical output and the classical output into a quantum format to produce a translated quantum input; and
integrating, by an integration module, the translated classical output and the alerts to produce a final result.

2. The method of claim 1, wherein preprocessing the raw dataset by the quantum data preprocessing module further comprises using SHA3 as the quantum-resistant hash function to produce the data hash.

3. The method of claim 2, wherein preprocessing the raw dataset by the quantum data preprocessing module further comprises using SPHINCS+ as the quantum-safe digital signature scheme to sign the data hash.

4. The method of claim 3, wherein encoding the quantum-safe signed dataset by the quantum encoding module further comprises implementing a BB84 protocol as the quantum key distribution protocol to generate a quantum key for encryption.

5. The method of claim 4, wherein extracting quantum features by the feature extraction layer further comprises configuring the variational quantum circuits with RY and RZ rotational gates to transform the entangled quantum state dataset.

6. The method of claim 5, wherein identifying anomalies by the variational quantum recurrent network further comprises setting the predefined threshold to 0.9 to distinguish the detected anomalies from the anomaly scores.

7. The method of claim 6, wherein generating alerts by the alert generation module further comprises assigning a severity rank to each of the alerts based on a magnitude of a corresponding anomaly score among the anomaly scores.

8. The method of claim 7, wherein processing the raw dataset by the classical neural network further comprises utilizing a convolutional neural network to analyze spatial patterns in the raw dataset and produce the classical output.

9. The method of claim 8, wherein translating by the multi-translation layer further comprises applying feature fusion to the optimized quantum features and the classical output during translation to enhance the translated classical output and the translated quantum input.

10. The method of claim 9, wherein integrating by the integration module further comprises logging the detected anomalies and the final result into a persistent storage system for subsequent analysis.

11. A method for detecting anomalies in network data using a hybrid quantum-classical framework, the method comprising:
acquiring, by a data acquisition module, raw data from user inputs and network traffic to form a raw dataset;
preprocessing, by a quantum data preprocessing module, the raw dataset to generate a quantum-safe signed dataset by applying a SHA3 quantum-resistant hash function to produce a data hash and signing the data hash with a SPHINCS+ quantum-safe digital signature scheme;
encoding, by a quantum encoding module, the quantum-safe signed dataset into a quantum-encoded dataset using a BB84 quantum key distribution protocol to generate a quantum key for encryption when the raw dataset is designated for quantum transfer;
entangling, by the quantum encoding module, qubits of the quantum-encoded dataset using a controlled NOT gate to produce an entangled quantum dataset;
validating, by a validation layer of a quantum neural network-intrusion detection model, integrity and authenticity of the quantum-safe signed dataset or the entangled quantum dataset to produce a validated dataset by recomputing the data hash and verifying the SPHINCS+ signature;
converting, by a quantum feature map layer of the quantum neural network-intrusion detection model, the validated dataset into a quantum state dataset by normalizing the validated dataset and applying amplitude encoding;
entangling, by the quantum feature map layer, qubits of the quantum state dataset using a controlled NOT gate to produce an entangled quantum state dataset;
extracting, by a feature extraction layer of the quantum neural network-intrusion detection model, quantum features from the entangled quantum state dataset using variational quantum circuits configured with RY and RZ parametrized rotational gates;
optimizing, by the feature extraction layer, the quantum features using a gradient descent optimizer to produce optimized quantum features;
identifying, by a variational quantum recurrent network of the quantum neural network-intrusion detection model, anomalies in the optimized quantum features by storing historical states in a quantum memory and classifying the optimized quantum features against the historical states to generate anomaly scores;
thresholding, by the variational quantum recurrent network, the anomaly scores against a predefined threshold of 0.9 to identify detected anomalies;
generating, by an alert generation module, alerts based on the detected anomalies and assigning a severity rank to each of the alerts based on a magnitude of a corresponding anomaly score among the anomaly scores;
processing, by a classical neural network, the raw dataset using a convolutional neural network to analyze spatial patterns and produce a classical output;
translating, by a multi-translation layer, the optimized quantum features into a classical format to produce a translated classical output and the classical output into a quantum format to produce a translated quantum input, wherein the translating includes applying feature fusion to enhance the translated classical output and the translated quantum input;
integrating, by an integration module, the translated classical output and the alerts to produce a final result and logging the detected anomalies and the final result into a persistent storage system for subsequent analysis;
adjusting, by a configuration module, a depth of the variational quantum circuits based on a complexity of the raw dataset; and
monitoring, by a performance module, a latency of the quantum neural network-intrusion detection model and dynamically scaling a number of quantum processors to maintain real-time processing.

12. A system for detecting anomalies in network data using a hybrid quantum-classical framework, the system comprising:
a data acquisition module configured to acquire raw data from user inputs and network traffic to form a raw dataset;
a quantum data preprocessing module configured to preprocess the raw dataset to generate a quantum-safe signed dataset by applying a quantum-resistant hash function to produce a data hash and signing the data hash with a quantum-safe digital signature scheme;
a quantum encoding module configured to encode the quantum-safe signed dataset into a quantum-encoded dataset using a quantum key distribution protocol when the raw dataset is designated for quantum transfer and to entangle qubits of the quantum-encoded dataset using a controlled NOT gate to produce an entangled quantum dataset;
a quantum neural network-intrusion detection model including:
a validation layer configured to validate integrity and authenticity of the quantum-safe signed dataset or the entangled quantum dataset to produce a validated dataset;
a quantum feature map layer configured to convert the validated dataset into a quantum state dataset by normalizing the validated dataset and applying amplitude encoding, and to entangle qubits of the quantum state dataset using a controlled NOT gate to produce an entangled quantum state dataset;
a feature extraction layer configured to extract quantum features from the entangled quantum state dataset using variational quantum circuits with parametrized rotational gates and to optimize the quantum features using a gradient descent optimizer to produce optimized quantum features; and
a variational quantum recurrent network configured to identify anomalies in the optimized quantum features by storing historical states in a quantum memory and classifying the optimized quantum features against the historical states to generate anomaly scores, and to threshold the anomaly scores against a predefined threshold to identify detected anomalies;
an alert generation module configured to generate alerts based on the detected anomalies;
a classical neural network configured to process the raw dataset to produce a classical output;
a multi-translation layer configured to translate the optimized quantum features into a classical format to produce a translated classical output and to translate the classical output into a quantum format to produce a translated quantum input; and
an integration module configured to integrate the translated classical output and the alerts to produce a final result.

13. The system of claim 12, wherein the quantum data preprocessing module is further configured to use SHA3 as the quantum-resistant hash function to produce the data hash.

14. The system of claim 13, wherein the quantum data preprocessing module is further configured to use SPHINCS+ as the quantum-safe digital signature scheme to sign the data hash.

15. The system of claim 14, wherein the quantum encoding module is further configured to implement a BB84 protocol as the quantum key distribution protocol to generate a quantum key for encrypting the quantum-safe signed dataset into the quantum-encoded dataset.

16. The system of claim 15, wherein the feature extraction layer of the quantum neural network-intrusion detection model is further configured to configure the variational quantum circuits with RY and RZ rotational gates to transform the entangled quantum state dataset into the quantum features.

17. The system of claim 16, wherein the variational quantum recurrent network of the quantum neural network-intrusion detection model is further configured to set the predefined threshold to 0.9 to distinguish the detected anomalies from the anomaly scores.

18. The system of claim 17, wherein the alert generation module is further configured to assign a severity rank to each of the alerts based on a magnitude of a corresponding anomaly score among the anomaly scores.

19. The system of claim 18, wherein the classical neural network is further configured to utilize a convolutional neural network to analyze spatial patterns in the raw dataset and produce the classical output.

20. The system of claim 19, wherein the multi-translation layer is further configured to apply feature fusion to the optimized quantum features and the classical output during translation to enhance the translated classical output and the translated quantum input.
